(19) United States
(12) Patent Application Publication
(10) Pub. No.: US 2026/0189929 A1
(43) Pub. Date: Jul. 2, 2026

(54) TERMINAL, BASE STATION, AND WIRELESS COMMUNICATION METHOD

(71) Applicant: NTT DOCOMO, INC., Tokyo (JP)

(72) Inventors: Daisuke Kurita, Tokyo (JP); Hiroki Harada, Tokyo (JP); Qiping Pi, Beijing (CN); Jing Wang, Beijing (CN); Lan Chen, Beijing (CN)

(73) Assignee: NTT DOCOMO, INC., Tokyo (JP)

(21) Appl. No.: 18/858,636

(22) PCT Filed: Apr. 27, 2022
(86) PCT No.: PCT/JP2022/019208

§ 371 Date: Oct. 21, 2024

(51) Int. Cl. H04W 16/28; H04W 24/10

(52) U.S. Cl. CPC H04W 16/28; H04W 24/10

(57) ABSTRACT

An aspect of the present disclosure provides a terminal comprising: a reception unit that receives a beam-based cross-link interference measurement setting; and a transmission unit that transmits a measurement result per beam acquired in accordance with the cross-link interference measurement setting.

### TECHNICAL FIELD

The present disclosure relates to a terminal, a base station and a wireless communication method.

### BACKGROUND ART

In Universal Mobile Telecommunications System (UMTS) networks, Long Term Evolution (LTE) has been standardized for the purpose of a higher data rate, low latency and the like. Also, LTE-Advanced (3GPP (Third Generation Partnership Project) Release (Rel.) 10-14) has been standardized for the purpose of a larger capacity, advancement and the like of the LTE (3GPP Rel. 8 and 9).

Successor systems of the LTE (referred to as 5^{th} generation mobile communication system (5G), 5G+ (plus), 6th generation mobile communication system (6G), New Radio (NR), 3GPP Rel. 15 and after or the like, for example) are being also discussed.

### CITATION LIST

### Non-Patent Literature

### Npl 1

“Initial Views on Release 18 NR” RP-210293, 3GPP TSG RAN Meeting #91-e Electronic Meeting, Mar. 16-26, 2021

### SUMMARY OF INVENTION

In a future radio communication system (for example, the NR), it is envisaged that multiple user terminals (User Equipments (UEs)) communicate under environments of ultra-high densities and high traffics.

In such environments, shortage of uplink (UL) resources compared to downlink (DL) resources is envisaged.

In previous NR specifications, however, methods for increasing the uplink resources have not been sufficiently discussed. If the methods cannot be controlled properly, there is a risk that system performance such as increases in latency and reduction in coverage performance may be reduced.

Thus, one objective of the present disclosure is to provide a terminal, a base station and a wireless communication method for enhancement of use efficiency of resources.

According to one aspect of the present disclosure, there is provided a terminal including a receiver that receives a beam-based cross link interference measurement configuration, and a transmitter that transmits a measurement result per beam obtained in accordance with the cross link interference configuration.

According to another aspect of the present disclosure, there is provided a terminal including a receiver that receives a subband based cross link interference measurement configuration, and a transmitter that transmits a measurement result per subband obtained in accordance with the cross link interference measurement configuration.

### BRIEF DESCRIPTION OF DRAWINGS

FIG. 1 is a block diagram for illustrating a functional arrangement of a base station (gNB) according to one embodiment of the present disclosure;

FIG. 2 is a block diagram for illustrating a functional arrangement of a terminal (UE) according to one embodiment of the present disclosure;

FIGS. 3A and 3B each illustrate an exemplary arrangement of radio resources in XDD (Cross Division Duplex) according to one embodiment of the present disclosure;

FIG. 4 is a diagram for illustrating an XDD operation according to one embodiment of the present disclosure;

FIGS. 5A to 5E each illustrate a pure time unit and an XDD time unit according to one embodiment of the present disclosure;

FIG. 6 is a diagram for illustrating a cross link interference (CLI) according to one embodiment of the present disclosure;

FIGS. 7A to 7D each illustrate an information element (IE) of a CLI-RSSI (Received Signal Strength Indicator) according to one embodiment of the present disclosure;

FIGS. 8A and 8B each illustrate a single-beam CLI-RSSI measurement according to one embodiment of the present disclosure;

FIG. 9 is a diagram for illustrating a multi-beam CLI-RSSI measurement according to one embodiment of the present disclosure;

FIGS. 10A and 10B each illustrate an exemplary report of a multi-beam CLI-RSSI measurement result according to one embodiment of the present disclosure;

FIGS. 11A and 11B each illustrate an exemplary report of a multi-beam CLI-RSSI measurement result according to one embodiment of the present disclosure;

FIGS. 12A to 12C each illustrate an exemplary report of a multi-beam CLI-RSSI measurement result according to one embodiment of the present disclosure;

FIGS. 13A to 13C each illustrate an exemplary report of a multi-beam CLI-RSSI measurement result according to one embodiment of the present disclosure;

FIGS. 14A and 14B each illustrate an exemplary report of a multi-beam CLI-RSSI measurement result according to one embodiment of the present disclosure;

FIGS. 15A and 15B each illustrate an exemplary measurement of multi-beam CLI-RSSI according to one embodiment of the present disclosure;

FIGS. 16A to 16C each illustrate an exemplary measurement of multi-beam CLI-RSSI according to one embodiment of the present disclosure;

FIG. 17 is a diagram for illustrating an exemplary measurement of multi-beam CLI-RSSI according to one embodiment of the present disclosure;

FIGS. 18A and 18B each illustrate an exemplary measurement of multi-beam CLI-RSSI according to one embodiment of the present disclosure;

FIGS. 19A to 19C each illustrate an exemplary measurement of multi-beam CLI-RSSI according to one embodiment of the present disclosure;

FIGS. 20A and 20B each illustrate an exemplary measurement of multi-beam CLI-RSSI according to one embodiment of the present disclosure;

FIGS. 21A and 21B each illustrate an exemplary measurement of multi-beam CLI-RSSI according to one embodiment of the present disclosure;

FIG. 22 is a diagram for illustrating an exemplary measurement of multi-beam CLI-RSSI according to one embodiment of the present disclosure;

FIGS. 23A and 23B each illustrate an exemplary measurement of multi-beam CLI-RSSI according to one embodiment of the present disclosure;

FIGS. 24A and 24B each illustrate an exemplary measurement of multi-beam CLI-RSSI according to one embodiment of the present disclosure;

FIG. 25 is a diagram for illustrating an exemplary measurement of multi-beam CLI-RSSI according to one embodiment of the present disclosure;

FIGS. 26A and 26B each illustrate an information element (IE) of a subband configuration for an XDD operation in a CLI-RSSI measurement resource configuration according to one embodiment of the present disclosure;

FIGS. 27A and 27B each illustrate an exemplary measurement of multi-subband CLI-RSSI according to one embodiment of the present disclosure;

FIG. 28 is a diagram for illustrating an exemplary measurement of multi-subband CLI-RSSI according to one embodiment of the present disclosure;

FIGS. 29A and 29B each illustrate an exemplary report of a multi-subband CLI-RSSI measurement result according to one embodiment of the present disclosure;

FIGS. 30A and 30B each illustrate an exemplary report of a multi-subband CLI-RSSI measurement result according to one embodiment of the present disclosure;

FIGS. 31A and 31B each illustrate an exemplary report of a multi-subband CLI-RSSI measurement result according to one embodiment of the present disclosure;

FIGS. 32A to 32C each illustrate an exemplary report of a multi-subband CLI-RSSI measurement result according to one embodiment of the present disclosure;

FIGS. 33A to 33C each illustrate an exemplary report of a multi-subband CLI-RSSI measurement result according to one embodiment of the present disclosure;

FIG. 34 is a block diagram for illustrating a hardware arrangement of a base station and a terminal according to one embodiment of the present disclosure; and

FIG. 35 is a block diagram for illustrating a hardware arrangement of a vehicle according to one embodiment of the present disclosure.

### DESCRIPTION OF EMBODIMENTS

Embodiments of the present disclosure are described below with reference to the drawings.

### (Radio Communication System)

In the following, an architecture of a radio communication system according to one embodiment of the present disclosure is described. In this radio communication system, communication is conducted using any or combinations of radio communication methods according to the above embodiments of the present disclosure. The radio communication system may be a system that implements communication using a Long Term Evolution (LTE), a 5th generation mobile communication system New Radio (5G NR), a subsequent radio communication system thereof or the like.

Also, the radio communication system may support dual connectivity among multiple Radio Access Technologies (RATs) (Multi-RAT Dual Connectivity (MR-DC)). The MR-DC may include dual connectivity (E-UTRA-NR Dual Connectivity (EN-DC)) for the LTE (Evolved Universal Terrestrial Radio Access (E-UTRA)) and the NR, dual connectivity for the NR and the LTE (NR-E-UTRA Dual Connectivity (NE-DC)) or the like.

In the EN-DC, abase station (eNB) in the LTE (E-UTRA) is a master node (MN), and a base station (gNB) in the NR is a secondary node (SN). In the NE-DC, a base station (gNB) in the NR is a master node, and a base station (eNB) in the LTE (E-UTRA) is a SN.

The radio communication system may support dual connectivity among multiple base stations within the same RAT (for example, dual connectivity where both the MN and the SN are base stations (gNBs) in the NR (NR-NR Dual Connectivity (NN-DC)).

The radio communication system may include a base station forming a macro cell C1 having a wider coverage and a base station disposed in the macro cell C1 and forming a smaller cell C2 than the macro cell C1. A terminal (UE) may be located within at least one cell. The location, number or the like of respective cells and terminals are not limited to a certain aspect.

A terminal may be connected to at least one of the multiple base stations. The terminal may use at least one of carrier aggregation (CA) using multiple component carriers (CCs) and the dual connectivity (DC).

Each CC may be included in at least one of a first frequency band (Frequency Range 1 (FR1) and a second frequency band (Frequency Range 2 (FR2)). The macro cell C1 may be included in the FR1, and the small cell C2 may be included in the FR2. For example, the FR1 may be a frequency band below 6 GHz (sub-6 GHz), and the FR2 may be a frequency band above 24 GHz (above-24 GHz). Note that the frequency bands, definitions or the like of the FR1 and FR2 are not limited to them, and the FR1 may correspond to a frequency band higher than the FR2, for example.

Also, the terminal may communicate in the respective CCs using at least one of Time Division Duplex (TDD) and Frequency Division Duplex (FDD).

The multiple base stations may be connected in a wired (for example, an optical fiber confirming to Common Public Radio Interface (CPRI), an X2 interface or the like) or wireless (for example, NR communication) manner. For example, the NR communication is used as a backhaul between two base stations, the base station corresponding to an upper station may be referred to as an Integrated Access Backhaul (IAB) donner, and the base station corresponding to a relay station may be referred to as an IAB node.

The base station may be connected via other base stations or to a core network directly. The core network may include at least one of an Evolved Packet Core (EPC), a 5G Core Network (5GCN), a Next Generation Core (NGC) or the like.

The terminal may support at least one of the LTE, the LTE-A, the 5G, the 6G and others.

In the radio communication system, an Orthogonal Frequency Division Multiplexing (OFDM) based radio access scheme may be used. For example, Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA) or the like may be used in at least one of downlink (DL) and uplink (UL).

The radio access scheme may be referred to as waveform. Note that other radio access schemes (for example, other single carrier transmission schemes, other multi-carrier transmission schemes or the like) may be used for UL and DL radio access schemes in the radio communication system.

In the radio communication system, a downlink shared channel (Physical Downlink Shared Channel (PDSCG)), a broadcast channel (Physical Broadcast Channel (PBCH)), a downlink control channel (Physical Downlink Control Channel (PDCCH)) and other shared among terminals may be used as downlink channels.

Also, in the radio communication system, an uplink shared channel (Physical Uplink Shared Channel (PUSCH)), an uplink control channel (Physical Uplink Control Channel (PUCCH)), a random access channel (Physical Random Access Channel (PRACH)) and others shared among terminals may be used as uplink channels.

User data, upper layer control information, a System Information Block (SIB) and others are transmitted in the PDSCH. User data, upper layer control information and others may be transmitted in the PUSCH. Also, a Master Information Block (MIB) may be transmitted in the PBCH.

Lower layer control information may be transmitted in the PDCCH. The lower layer control information may include downlink control information (DCI) including scheduling information for at least one of the PDSCH and the PUSCH, for example.

Note that the DCI for scheduling the PDSCH may be referred to as a DL assignment, DL DCI or the like, and the DCI for scheduling the PUSCH may be referred to as an UL grant, UL DCI or the like. Note that the PDSCH may be interchangeably referred to as DL data, and the PUSCH may be interchangeably referred to as UL data.

A control resource set (CORESET) and a search space may be used to detect the PDCCH. The CORESET corresponds to a resource for searching for the DCI. The search space corresponds to a search area and a search method for a PDCCH candidate. One CORESET may be associated with one or more search spaces. A UE may monitor for the CORESET associated with a certain search space based on a search space configuration.

One search space may correspond to a PDCCH candidate relevant to one or more aggregation levels. One or more search spaces may be referred to as a search space (SS) set. Note that “search space”, “search space set”, “search space configuration”, “search space set configuration”, “CORESET”, “CORESET configuration” or the like of the present disclosure may be interchangeably referred to as each other.

Uplink control information (UCI) including at least one of channel state information (CSI), acknowledgement information (referred to as Hybrid Automatic Repeat request ACKnowledgement (HARQ-ACK), ACK/NACK or the like, for example) and a scheduling request (SR) may be transmitted in the PUCCH. A random access preamble for connection establishment to a cell may be transmitted in the PRACH.

Note that various channels may be represented without adding the wording “Physical” at the header

In the radio communication system, a synchronization signal (SS), a downlink reference signal (DL-RS) and others may be transmitted. In the radio communication system, a cell-specific reference signal CRS), a channel state information reference signal (CSIU-RS), a demodulation reference signal (DMRS), a positioning reference signal (PRS), a phase tracking reference signal (PTRS) and others may be transmitted as the DL-RS.

For example, the synchronization signal may be at least one of a primary synchronization signal (PSS) and a secondary synchronization signal (SSS). A signal block including the SS (the PSS and the SSS) and the PBCH (and the DMRS for the PBCH) may be referred to as a SS/PBCH block, a SS block (SSB) or the like. Note that the SS, the SSB or the like may be also referred to as a reference signal.

Also, in the radio communication system, a sounding reference signal (SRS), a demodulation reference signal (DMRS) and others may be transmitted as an uplink reference signal (UL-RS). Note that the DMRS may be referred to as a UE-specific reference signal.

### (Device Arrangement)

Next, exemplary functional arrangements of a base station (gNB) and a terminal (UE) 200 that perform processes and operations as stated below are described. The gNB 100 and the UE 200 include functionalities for implementing the embodiments as stated below. Note that each of the gNB 100 and the UE 200 may include only a portion of the functionalities of the embodiments.

(gNB 100)

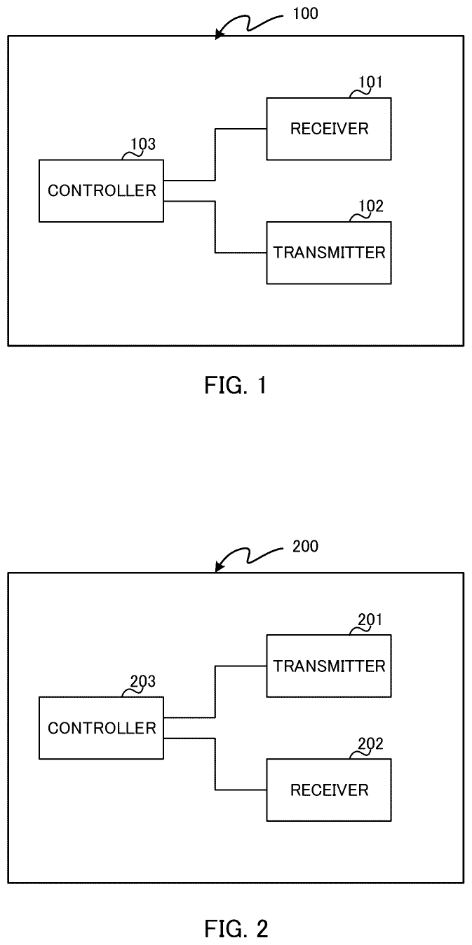

FIG. 1 is a diagram for one exemplary functional arrangement of the gNB 100. As illustrated in FIG. 1, the gNB 100 includes a receiver 101, a transmitter 102 and a controller 103. The functional arrangement as illustrated in FIG. 1 is merely one example. If operations associated with embodiments of the present invention can be practiced, separation of functionalities and names of the functional units are arbitrary.

The receiver 101 include a functionality of receiving various signals transmitted from the UE 200 and acquiring upper layer information from the received information, for example. The transmitter 102 includes a functionality of generating signals for transmission to the UE 200 and transmitting the signals in a wired or wireless manner.

The controller 103 stores preset configuration information and various configuration information for transmission to the UE 200 in a memory device and reads them from the memory device if necessary. Also, the controller 103 performs operations associated with communication with the UE 200. The functional unit regarding signal transmission at the controller 103 may be included in the transmitter 102, and the functional unit regarding signal reception at the controller 103 may be included in the receiver 101.

### (UE 200)

FIG. 2 is a diagram for illustrating one exemplary functional arrangement of the UE 200. The UE 200 includes a transmitter 201, a receiver 202 and a controller 203. The functional arrangement as illustrated in FIG. 2 is merely one example. If operations associated with embodiments of the present invention can be practiced, separation of functionalities and names of the functional units are arbitrary.

The transmitter 201 generates a transmission signal from transmission data and transmits the transmission signal in a wireless manner. The receiver 202 receives various signals wirelessly and acquires upper layer signals from the received physical layer signals. Also, the receiver 202 has a functionality of receiving a NR-PSS, a NR-SSS, a NR-PBCH, a DL/UL control signal a reference signal or the like transmitted from the gNB 100.

The controller 203 stores various configuration information received at the receiver 202 from the gNB 100 in a memory device and reads them from the memory device if necessary. Also, the controller 203 performs operations associated with communication with the gNB 100. The functional unit regarding signal transmission at the controller 203 may be included in the transmitter 201, and the functional unit regarding signal reception at the controller 203 may be included in the receiver 202.

(XDD operation)

Taking into account a time ratio of transmission and reception (for example, DL:UL=4:1) in time division duplex (TDD) until Rel. 16, some cases of transmission occasions of UL signals/channels being smaller than reception occasions of DL signals/channels may be considered. In these cases, the UE cannot transmit UL signals/channels frequently, and transmission delay of important UL signals/channels may arise. Also, since the UL transmission occasions are smaller than the DL reception occasions, signals/channels may be congested in the UL transmission occasions. In addition, since the UL signals/channels can be transmitted in a limited amount of time resources in the TDD, UL coverage enhancement technique with repetition may be also limitedly applied.

For future radio communication systems (for example, Rel. 17/18 and subsequent ones), it is discussed that a division duplex scheme where the TDD and frequency division duplex (FDD) are combined for UL and DL will be introduced.

The division duplex scheme may be referred to as XDD (Cross Division Duplex) or subband non-overlapping full duplex. The XDD or the subband non-overlapping full duplex may mean a duplex scheme where DL and UL are duplexed in a frequency division manner in one component carrier (CC) in a TDD band (the DL and the UL are simultaneously available).

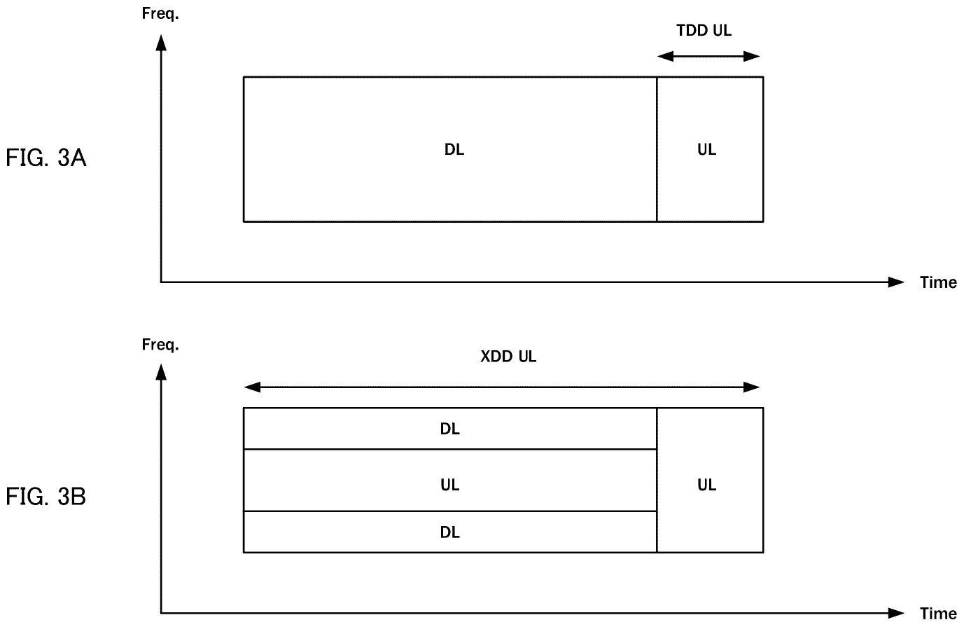

FIG. 3A is a diagram for illustrating one exemplary TDD configuration provided until Rel. 16. In the example as illustrated in FIG. 3A, a TDD slot or symbol is configured for the UE in a bandwidth such as one component carrier (CC) (which may be referred to as a cell or a serving cell) or a bandwidth part (BWP).

In the example as illustrated in FIG. 3A, the time ratio of DL slots and UL slots is 4:1. In such a conventional slot or symbol configuration in the TDD, a sufficient amount of UL time resources cannot be reserved, which may lead to UL transmission delay and reduce coverage performance.

FIG. 3B is a diagram for illustrating one exemplary XDD configuration. In the example as illustrated in FIG. 3B, there is an overlap in time between resources used for DL reception and resources used for UL transmission in one component carrier (CC). According to such a resource configuration, a larger amount of UL resources can be reserved, which can improve utilization efficiency of the resources.

For example, as illustrated in FIG. 3B, both ends in a frequency area may be configured for DL resources, and UL resources may be configured to be sandwiched between these DL resources. As a result, occurrence of cross link interference (CLI) with adjacent carriers can be avoided and reduced. Also, a guard area may be configured at the boundary between the DL resources and the UL resources.

Taking operational complexity of self-interference into account, it may be considered that only base stations use DL resources and UL resources simultaneously. In other words, for radio resources where DL and UL overlap temporally, a certain UE may use a DL resources, and another UE may use an UL resource.

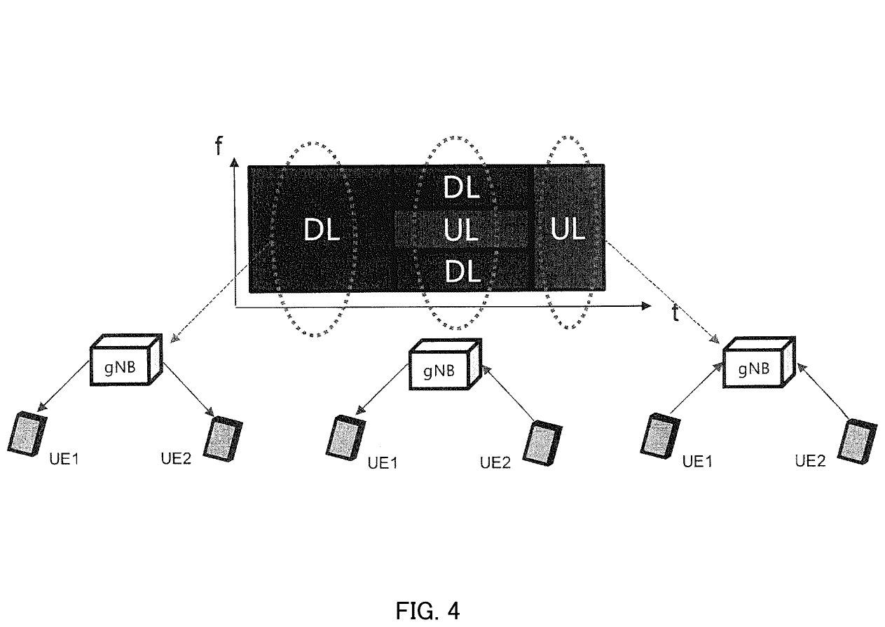

FIG. 4 is a diagram for illustrating one exemplary XDD operation. In the example as illustrated in FIG. 4, a portion of DL resources in a TDD band is configured for UL resources, and the DL and the UL are arranged to partially overlap with respect to the temporal domain.

In the example as illustrated in FIG. 4, each of multiple UEs (UE #1 and UE #2 in FIG. 4) receives a DL channel/signal in a DL exclusive period.

Also, in period where there is temporal overlapping between DL and UL, a certain UE (UE #1 in the example of FIG. 4) receives a DL channel/signal, and another UE (UE #2 in the example of FIG. 4) transmits an UL channel/signal. A base station performs simultaneous transmission and reception of DL and UL in this period.

Also, each of multiple UEs (UE #1 and UE #2 in FIG. 4) transmits an UL channel/signal in an UL exclusive period.

In the existing NR (defined until Rel. 15/16, for example), each of a DL frequency resource and an UL frequency resource in a carrier for UEs is configured as a DL BWP and an UL BWP. A mechanism for configuration for multiple BWPs and BWP adaptation is needed to switch the DL/UL frequency resource into another DL/UL frequency resource.

Also, in the existing NR, a time resource in a TDD carrier for UEs is configured as at least one of DL, UL and flexible (FR) in the TDD configuration.

An XDD symbol may be a symbol that is indicated or configured as UL (or DL) or is indicated or configured for UL transmission (or DL reception) in certain frequency resources, whereas the XDD symbol may be a symbol that is indicated or configured as DL (or UL) or is indicated or configured for DL reception (or UL transmission) in other frequency resources. Alternatively, an XDD symbol may be a symbol that is indicated or configured as UL (or DL) or is indicated or configured for UL transmission (or DL reception) in a portion of certain frequency resources, whereas the XDD symbol may be a symbol that is indicated or configured as DL (or UL) or is indicated or configured for DL reception (or UL transmission) in a portion of other frequency resources.

A time unit herein may be a symbol level, a slot/subslot level, or a group of symbols/slots/subslots. Namely, an XDD time unit may be an XDD symbol, a slot/subslot including or overlapping with the XDD symbol, or a group of symbols/slots/subslots including or overlapping with the XDD symbol.

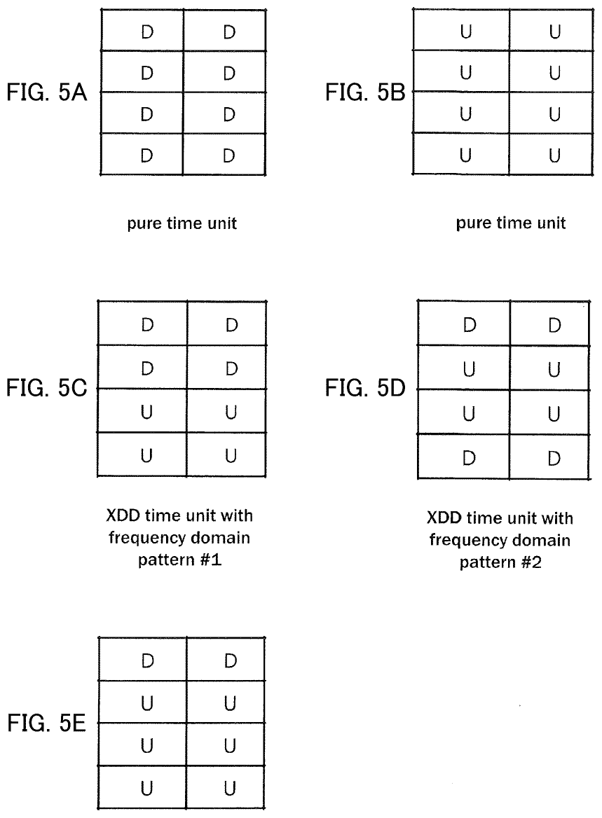

A pure time unit may be a non-XDD symbol (that is, a symbol that is not an XDD symbol), a slot/subslot including or overlapping with no XDD symbol, or a group of symbols/slots/subslots including or overlapping with no XDD symbol, and may be referred to as a non XDD time unit. For example, the pure time unit may be referred to as a time unit consisting of only DL in a frequency resource as illustrated in FIG. 5A or may be referred to as a time unit consisting of only UL in the frequency resource as illustrated in FIG. 5B.

Also, DL resources and UL resources may have various arrangement patterns in a frequency domain with respect to the XDD time unit. For example, the XDD time unit for frequency domain pattern #1 may have an arrangement pattern as illustrated in FIG. 5C. Also, the XDD time unit for frequency domain pattern #2 may have an arrangement pattern as illustrated in FIG. 5D. Also, the XDD time unit for frequency domain pattern #3 may have an arrangement pattern as illustrated in FIG. 5E. These arrangement patterns are merely illustrative, and the XDD time unit may have other arrangement patterns. The frequency domain pattern in the XDD time unit may mean a resource repetition pattern in the frequency domain for the XDD time unit.

### (Cross Link Interference)

A solution for managing cross link interference between base stations and cross link interference between UEs is needed for introduction of the XDD operation into an NR duplex operation. Also, intra-subband CLI and inter-subband CLI must be considered in cases of subband non-overlapping full duplex.

A Sounding Reference Signal Reference Signal Received Power (SRS-RSRP) is defined as a linear average of power contribution of resource elements for carrying a sounding reference signal (SRS). The SRS-RSRP is measured for resource elements configured within a measurement frequency bandwidth in a measurement time occasion.

In an SRS-ResourceConfigCLI configuration, information elements (IEs) such as an SRS resource (srs-Resource), a subcarrier spacing (srs-SCS), a serving cell index (refServCellindex), a BWP ID (refBWP) and the like are configured.

A Cross Link Interference Received Signal Strength Indicator (CLI-RSSI) in Rel-16 is defined as a linear average of total receive power observed in only OFDM symbols configured in measurement time resources configured in a measurement bandwidth configured from all sources including a co-channel serving and non-serving cell, adjacent channel interference, heat noise and the like.

In an RSSI-ResourceConfigCLI configuration in Rel-16, information elements (IEs) such as an RSSI resource ID (rssi-ResourceId), a subcarrier spacing (rssi-SCS), a start PRB (Physical Resource Block) (startPRB), a lowed size of a measurement bandwidth (nrofPRBs), a start position for measurement (startPosition), the number of symbols for measurement (nrofSymbols), a periodicity and an offset for measurement (rssi-PeriodicityAndOffset), a serving cell index (refServCellIndex) and the like are configured.

### (Problems)

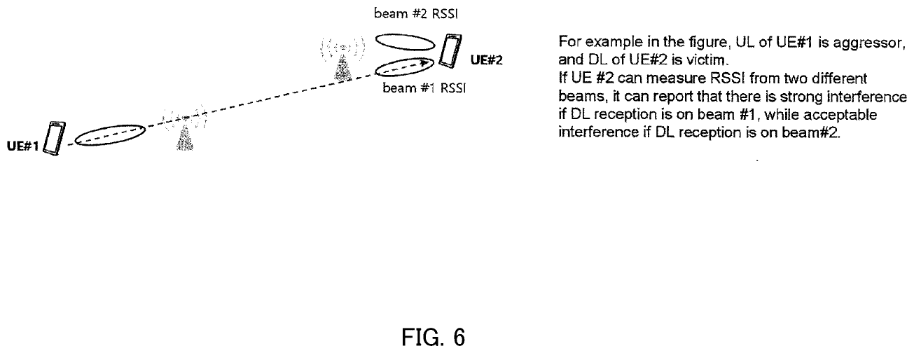

For enhancement of CLI-RSSI measurement and report, possibilities below may be considered.
i) Range of new parameter values in the CLI-RSSI resource configuration: Values supported for several parameters may have to be enhanced. For example, the value range presently supported for the subcarrier spacing (SCS) is not supported for the SCS of 480/960 kHz in FR 2-2.
ii) Beam specific CLI-RSSI measurement and report: In Rel-16, beam specific CLI-RSSI measurement and report are not supported. In FR2 and FR2-2, a narrow beam operation is important. By beam level CLI-RSSI measurement and report, separation of a spatial domain can be effective for interference reduction. As illustrated in FIG. 6, uplink transmission of UE #1 may be an aggressor, and downlink reception of UE #2 may be a victim. In other words, if UE #2 measures the RSSI from beams #1 and #2, there is a likelihood that a strong interference can be detected on beam #1 due to uplink transmission of UE #1.
iii) Subband for CLI-RSSI measurement: Subbands for CLI-RSSI measurement may differ between XDD time units and non-XDD time units. For example, a configured subband is not available to downlink, and non-continuous subband measurement may be needed for the XDD operation.

### First Embodiment

In the first embodiment, enhanced parameter value candidates in a CLI-RSSI resource configuration are supported.

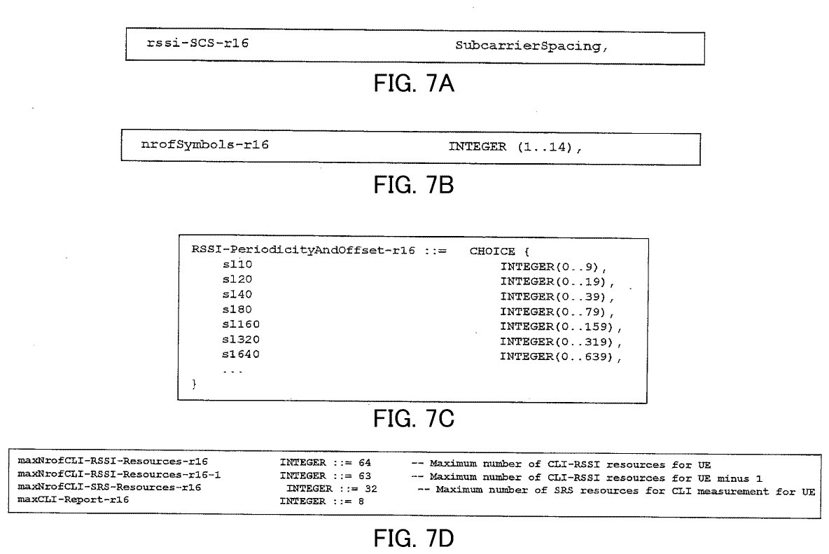

As the first proposal, new candidate values may be supported for an rssi-scs indicative of a reference SCS for CLI-RSSI measurement as illustrated in FIG. 7A. In rssi-scs in Rel-16, 15, 30 and 60 kHz for FR1 and 60 and 120 kHz for FR2 can be applied, but SCS of 240, 480 and 960 kHz may be further applied. In other words, the CLI-RSSI resource configuration may include candidate values of parameters (rssi-SCS or the like) for the SCS applied in a high frequency band such as FR2-2, for example.

As the second proposal, new candidate values may be supported for nrofSymbols indicative of the number of symbols for CLI-RSSI measurement as illustrated in FIG. 7B. The candidate values of 1 to 14 can be applied for nrofSymbols in Rel-16, but candidate values greater than 14 may be further introduced. In other words, the CLI-RSSI resource configuration may include candidate values of parameters (nrofSymbols) for configuring measurement time exceeding the number of symbols in a slot. Accordingly, the CLI-RSSI measurement for a longer time is enabled. Also, not only the measurement time per symbol but also the measurement time per slot may be configured, and a new parameter such as nrofSlots may be configured.

As the third proposal, new candidate values may be supported for an RSSI-PeriodicityAndOffset indicative of a measurement resource periodicity of CLI-RSSI as illustrated in FIG. 7C. For example, a smaller periodicity than 10 slots and/or a larger periodicity than 640 slots may be supported. In other words, the CLI-RSSI resource configuration may include candidate values of parameters (RSSI-PeriodicityAndOffset or the like) for configuring a larger measurement resource periodicity, for example.

As the fourth proposal, greater candidate values than 64 such as 128 may be supported for a maxNrofCLI-RSSI-Resources indicative of the number of resources for CLI-RSSI measurement as illustrated in FIG. 7D. In other words, the CLI-RSSI resource configuration may include candidate values of parameters (maxNrofCLI-RSSI-Resources and the like) for configuring the larger number of measurement resources, for example.

As the fifth proposal, greater candidate values than 8 such as 16 may be supported for a maxCLI-Report indicative of the number of reports for CLI-RSSI measurement results as illustrated in FIG. 7D. In other words, the CLI-RSSI resource configuration may include candidate values of parameters (maxCLI-Report and the like) for configuring the larger number of reports, for example.

In this manner, in the first embodiment, a base station configures enhanced parameter values for various parameters for a CLI-RSSI measurement configuration and transmits the CLI-RSSI measurement configuration indicative of the enhanced parameter values to a UE. Upon receiving the CLI-RSSI measurement configuration, the UE may perform the enhanced CLI-RSSI measurement in accordance with the received CLI-RSSI measurement configuration.

According to the first embodiment, the enhanced CLI-RSSI measurement can be achieved.

### Second Embodiment

One exemplary solution for obtaining multiple CLI-RSSI measurement results for different beams is provided. In the second embodiment, one beam may be configured for measurement or report in one RSSI resource configuration. To this end, multiple RSSI resource configurations can be configured to obtain measurement results of multiple beams.

According to the second embodiment, beam unit based CLI-RSSI measurement (and report) may be supported with single-beam measurement per CLI-RSSI measurement resource

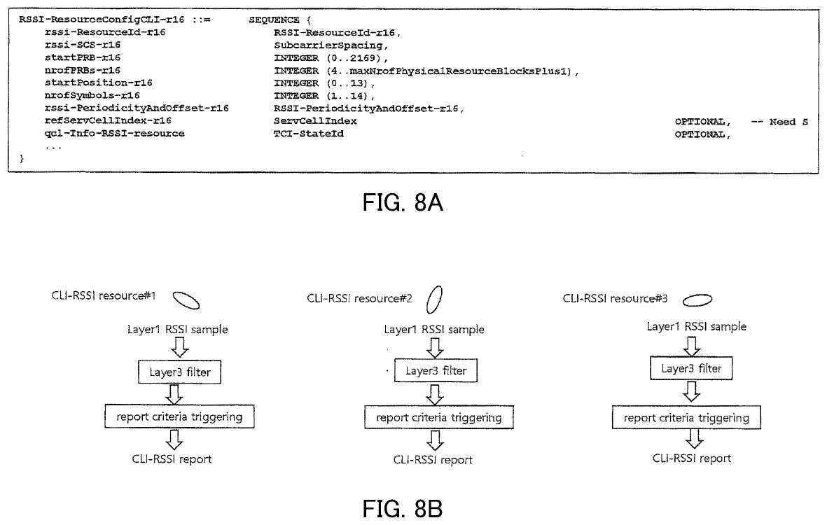

Specifically, a TCI (Transmission Configuration Indicator) state (or a reference signal (RS) of QCL-TypeD) may be explicitly configured for CLI-RSSI measurement resources. For example, as illustrated in FIG. 8A, a parameter of qcl-Info-RSSI-resource may be configured to indicate the TCI state for CLI-RSSI measurement.

For each CLI-RSSI measurement resource, a UE measures receive power with a received beam for which the TCI state (or QCL-TypeD RS) is configured. The RSSI sample values for measured layer 1 are provided to layer 3 for triggering of filtering (for example, averaging or the like) and report criteria.

For example, as illustrated in FIG. 8B, for the TCI state of CLI-RSSI resource #1, an RSSI measurement result is obtained in layer 1, and filtering is performed in layer 3. When a report criteria triggering condition is satisfied, a CLI-RRSI of the TCI state of filtered CLI-RSSI resource #1 is reported. Similarly, for the TCI state of CLI-RSSI resource #2, an RSSI measurement result is obtained in layer 1, and filtering is performed in layer 3. When the report criteria triggering condition is satisfied, a CLI-RRSI of the TCI state of filtered CLI-RSSI resource #2 is reported Also, for the TCI state of CLI-RSSI resource #3, an RSSI measurement result is obtained in layer 1, and filtering is performed in layer 3. When the report criteria triggering condition is satisfied, a CLI-RRSI of the TCI state of filtered CLI-RSSI resource #3 is reported.

If such an explicit TCI state or QCL-TypeD RS is not configured, a UE may envisage that one of the most recently received PDSCH, the most recently monitored CORESET (Control Resource SET), the CORESET having the minimum index monitored in the most recent slot, and/or the TCI state having the minimum index in the most recent slot is configured in QCL-TypeD as the CLI-RSSI measurement resources.

As one exemplary variation, the TCI state (or QCL-TypeD RS) configured for CLI-RSSI measurement resources may or may not be dynamically updated by an RRC (Radio Resource Control) information element, a DCI (Downlink Control Information) and a MAC CE (Medium Access Control Control Element).

Also, as one exemplary variation, CLI-RSSI resource settings may be introduced. Each CLI-RSSI resource setting may include multiple CLI-RSSI resources.

As Option 1, a beam list including multiple beams may be configured for the CLI0RSSI resource setting, and each CLI-RSSI resource in the CLI-RSSI resource setting may correspond to one beam in the list in a one-to-one mapping manner. For example, {beam #1, beam #2, beam #3, beam #4} may be configured for the CLI-RSSI resource setting including {RSSI resource #1, RSSI resource #2, RSSI resource #3, RSSI resource #4}. In this case, beam #1 may correspond to RSSI resource #1, beam #2 may correspond to RSSI resource #2, beam #3 may correspond to RSSI resource #3, and beam #4 may correspond to RSSI resource #4.

As Option 2, a certain beam may be configured for the CLI-RSSI resource setting, and this beam may be applied to all CLI-RSSI resources in the CLI-RSSI resource setting. For example, {beam #1} may be configured for the CLI-RSSI resource setting including {RSSI resource #1, RSSI resource #2, RSSI resource #3, RSSI resource #4}. In this case, beam #1 may correspond to RSSI resource #1, beam #1 may correspond to RSSI resource #2, beam #1 may correspond to RSSI resource #3, and beam #1 may correspond to RSSI resource #4.

According to the second embodiment, a solution for obtaining multiple CLI-RSSI measurement results for different beams can be provided.

### Third Embodiment

One exemplary solution for obtaining multiple CLI-RSSI measurement results for different beams is provided. According to the third embodiment, CLI-RSSI measurement (and report) per beam may be supported by multi-beam measurement for each CSI-RSSI measurement resource. In this case, several problems below can be considered.

As the first problem, beam settings for CLI-RSSI measurement resources must be defined.

As the second problem, report contents of measurement results for CLI-RSSI measurement resources where multiple beams are configured must be defined.

As the third problem, it must be defined how to determine whether report criteria are satisfied.

As the fourth problem, it must be defined which beam is measured in layer 1 for CLI-RSSI measurement resources where multiple TCI states are configured.

As the fifth problem, it must be defined how to measure CLI-RSSI for multiple beams for CLI-RSSI measurement resources.

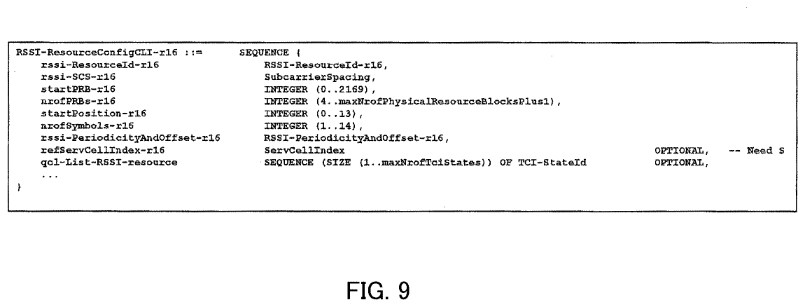

As the first problem, beam setting for CLI-RSSI measurement resources must be defined. For the first problem, for the beam setting for CLI-RSSI measurement resources, the list of TCI states (or QCL-TypeD RS) may be explicitly configured for CLI-RSSI measurement resources. For example, as illustrated in FIG. 9, the list of TCI states may be configured in qcl-List-RSSI-resource parameter in an RSSI-ResourceConfigCLI. Here, the maximum number of TCI states (or QCL-TypeD RS) in the list may be defined in specifications or configured by an RRC.

As one exemplary variation, the list of TCI states (or QCL-TypeD RS) configured for CLI-RSSI measurement resources may or may not be dynamically updated by at least one of an RRC information element, a DCI and a MAC CE.

As the second problem, report contents of measurement results for CLI-RSSI measurement resources where multiple beams are configured must be defined. For the second problem, the measurement results for CLI-RSSI measurement resources where multiple beams are configured may be reported with contents below.

As Option 1, a UE may obtain measurement results of layer 3 for respective configured beams and select a to-be-reported beam. In other words, the UE may obtain an RSSI sample value of layer 1 for each configured beam, filter (for example, average) the obtained RSSI sample value in layer 3 for each beam, and report the filtered RSSI value to a base station or others.

In Option 1-1, a UE may report an RSSI value per beam for each measured beam. In other words, the UE may obtain an RSSI sample value in layer 1 (L1) for each measured beam, filter (for example, average) the obtained RSSI sample value in layer 3 for each beam, and report the filtered RSSI value as the RSSI value per beam to a base station or others.

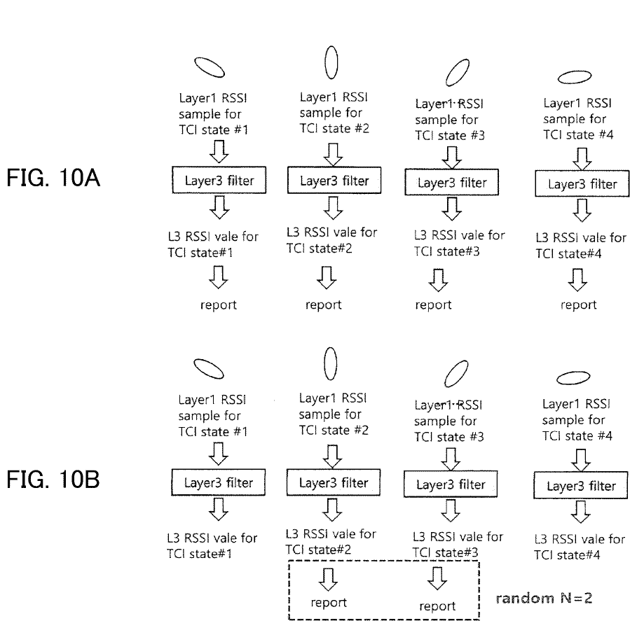

According to Option 1-1, for example, as illustrated in FIG. 10A, a UE measures respective beams for the configured TCI states #1 to #4 and obtains RSSI sample values for the respective beams in layer 1. The UE filters the RSSI sample values for the respective obtained beams in layer 3 and reports the RSSI values for the respective beams. In this manner, the UE reports the RSSI values for all the TCI states #1 to #4.

In Option 1-2, a UE may report the RSSI values per beam for randomly selected N number of RSSI values. In other words, for the respective measured beams, the UE may obtain the RSSI sample values in layer 1 (L1), filter (for example, average or the like) the obtained RSSI sample values in layer 3 per beam, and report the N number of RSSI values randomly selected from the filtered RSSI values as the RSSI value per beam to a base station and others. Here, the N value may be defined by specifications or configured by an RRC.

According to Option 1-2, for example, as illustrated in FIG. 10B, a UE measures the respective beams for the configured TCI states #1 to #4 and obtains the RSSI sample values for the respective beams in layer 1. The UE filters the obtained RSSI sample values for the respective beams in layer 3 and report the randomly selected N number of RSSI values. In the illustrated example, the two RSSI values for the TCI states #2 and #3 are selected, and the UE reports the RSSI values for the TCI states #2 and #3.

In Option 1-3, a UE may report RSSI values for respective beams for the RSSI values greater than or equal to a threshold. In other words, for the respective measured beams, the UE obtains the RSSI sample values in layer 1 (L1) and filters (for example, averages or the like) the obtained RSSI sample values in layer 3 for the respective beams. Then, the UE may report the RSSI values greater than or equal to a threshold among the filtered RSSI values as the RSSI value per beam to a base station or others. Here, the threshold may be defined by specifications or configured by an RRC.

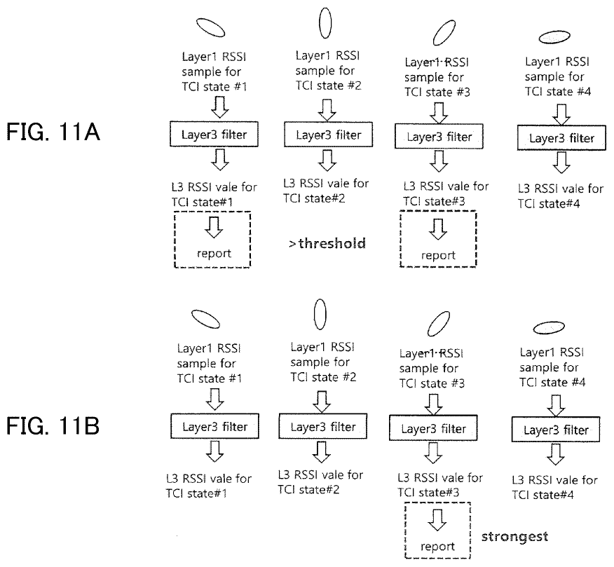

According to Option 1-3, for example, as illustrated in FIG. 11A, a UE measures respective beams of the configured TCI states #1 to #4 and obtains RSSI sample values for the respective beams in layer 1. The UE filters the obtained RSSI sample values for the respective beams in layer 3 and reports the RSSI values greater than or equal to a threshold. In the illustrated example, the two RSSI value for the TCI states #1 and #3 is greater than or equal to the threshold, and the UE reports the RSSI values for the TCI states #1 and #3.

In Option 1-4, a UE may report RSSI values for respective beams for the N number of the highest or lowest RSSI values. In other words, for the respective measured beams, the UE obtains the RSSI sample values in layer 1 (L1) and filters (for example, averages or the like) the obtained RSSI sample values in layer 3 per beam. Then, the UE may report the N number of the highest or lowest RSSI values among the filtered RSSI values as the RSSI value per beam to a base station or others. Here, the N value may be defined by specifications or configured by an RRC.

According to Option 1-4, for example, as illustrated in FIG. 11i, a UE measures respective beams for the configured TCI states #1 to #4 and obtains the RSSI sample values for the respective beams in layer 1. The UE filters the obtained RSSI sample values for the respective beams in layer 3 and reports the highest RSSI value. In the illustrated example, N=1, and the RSSI value for the TCI state #3 is the highest, and the UE reports the RSSI value for the TCI state #3.

As stated above, according to Option 1, the RSSI values for the respective beams may be reported. In this case, several options for ordering the RSSI values in a measurement report can be considered.

As Option 1, to-be-reported RSSI values may be ordered in the ascending or descending order of TCI state indices (or indices in the configured beam list). For example, if the RSSI values for the TCI state indices #1, #2, . . . , #n are reported, the UE may report RSSI value #1 for the TCT state index #1, RSSI value #2 for the TCT state index #2, . . . , RSSI value #n for the TCT state index #n in the ascending order of the TCI state indices. Alternatively, if the RSSI values for the TCI state indices #1, #2, . . . , #n, the UE may report RSSI value #n for the TCI state index #n, RSSI value #n−1 for the TCI state index #n−1, . . . , RSSI value #1 for the TCT state index #1 in the descending order of the TCI state indices. Here, selection of the ascending order or the descending order may be defined by specifications or configured by an RRC.

As Option 2, to-be-reported RSSI values may be ordered in the ascending or descending order of RSSI values. For example, if the RSSI values for the TCI state indices #1, #2, . . . , #n are reported, the UE may report the lowest RSSI value #i_1 and the corresponding TCI state index #i_1, the second lowest RSSI value #i_2 and the corresponding TCI state index #i_2, . . . , the highest RSSI value #i_n and the corresponding TCI state index #i_n in the ascending order of RSSI values. Alternatively, if the RSSI values for the TCI state indices #1, #2, . . . , #n are reported, the UE may report the highest RSSI value #j_1 and the corresponding TCI state index #j_1, the second highest RSSI value #j_2 and the corresponding TCI state index #j_2, . . . , the lowest RSSI value #j_n and the corresponding TCI state index #j_n in the descending order of RSSI values. Here, selection of the ascending order or the descending order may be defined by specifications or configured by an RRC.

Also, it may be defined by specifications or configured by an RRC which of the options is applied.

Also, several options for formats of to-be-reported RSSI values may be considered.

As Choice a, {TCI state index (or an index in a configured beam list), RSSI value} is reported, and the respective RSSI values may be reported in their absolute values.

As Choice b, {TCI state index (or an index in a configured beam list), RSSI value} is reported, and the first RSSI value may be reported in its absolute value whereas RSSI values other than the first RSSI value may be reported in their relative values. For example, the relative value may be a delta RSSI value representing an offset or a difference to the first RSSI value.

A reference RSSI value (for example, a maximum/minimum/average RSSI value or the like) is reported in the absolute value of RSSI, and {TCI state index (or an index in a configured beam list), RSSI value} may be reported. The RSSI value herein may be a relative value (for example, the delta RRSI value representing an offset or a difference to the reported RSSI absolute value). Also, if a predetermined RSSI value is applied as the reference RSSI value, the reference RSSI value may not be reported. The predetermined RSSI value may be defined by specifications or configured by an RRC.

Note that the absolute value may be m-bit value in the range of [a, b] dBm by c dB step size. Here, the RSSI bit length m, the lower bound a, the upper bound b and the step size c may be defined by specifications or configured by an RRC. For example, similar to the current specifications, the absolute value may be a 7-bit value in the range of [−100, −25] dBm by the step size of 1 dB. On the other hand, the relative value may be an n-bit value in the range [a1, b1] dBm by the step size of c1 dB. Here, the RSSI bit length n, the lower bound a1, the upper bound b1 and the step size c1 may be defined by specifications or configured by an RRC.

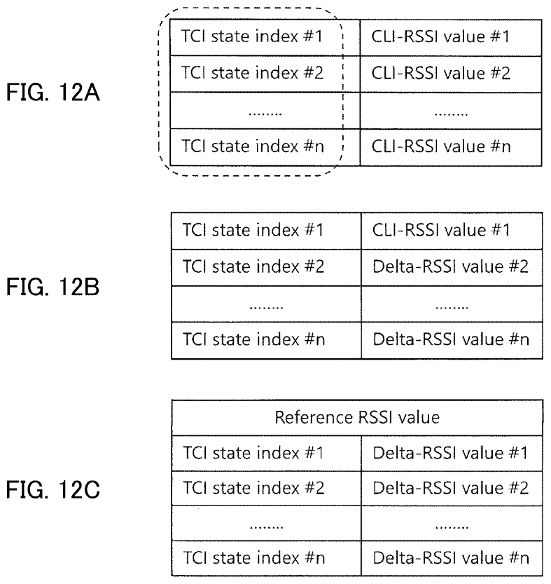

According to Option 1 and Choice a, for example, as illustrated in FIG. 12A. a UE may report RSSI value #1 for the TCI state index #1, RSSI value #2 for the TCI state index #2, . . . , RSSI value #n for the TCI state index #n in the ascending order of TCI state indices. Here, the RSSI values #1 to #n are the absolute values of RSSI. Note that if a UE always reports RSSI values for respective configured beams in the ascending or descending order of TCI state indices (or indices in a configured beam list), the TCI state indices (or the indices in the configured beam list) may not be explicitly reported.

According to Option 1 and Choice b, for example, as illustrated in FIG. 12B, a UE may report RSSI value #1 for the TCI state index #1, delta RSSI value #2 for the TCI state index #2, . . . , delta RSSI value #n for the TCI state index #n in the ascending order of the TCI state indices. Here, the RSSI value #1 is an absolute value of RSSI, and the RSSI values #2 to #n are relative values representing offsets or differences to the RSSI value #1.

According to Option 1 and Choice c, for example, as illustrated in FIG. 12C, a UE may report RSSI value #1 for the TCI state index #1, delta RSSI value #2 for the TCI state index #2, . . . , delta RSSI value #n for the TCI state index #n in the ascending order of the TCI state indices together with a reference RSSI value. Here, the delta RSSI values #1 to #n are relative values representing offsets or differences to the reference RSSI value.

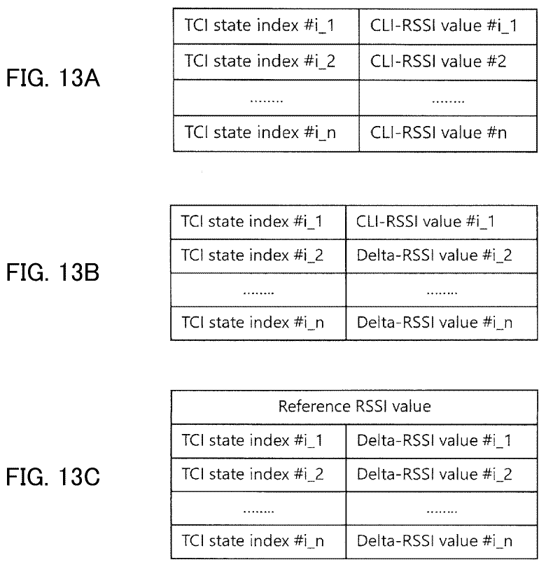

According to Option 2 and Choice a, for example, as illustrated in FIG. 13A, a UE may report RSSI value #i_1 for the TCI state index #i_1, RSSI value #i_2 for the TCI state index #i_2, . . . , RSSI value #i_n for the TCI state index #i_n in the ascending order of RSSI values. Here, the RSSI values #i_1 to #i_n are absolute values of RSSI values.

According to Option 2 and Choice b, for example, as illustrated in FIG. 13B, a UE may report RSSI value #i_1 for the TCI state index #i_1, delta RSSI value #i_2 for the TCI state index #i_2, . . . , delta RSSI value #i_n for the TCI state index #i_n in the ascending order of RSSI values. Here, the RSSI value #1 is an absolute value of RSSI, and the delta RSSI values #i_2 to #i_n are relative values representing offsets or differences to the RSSI value #i_1.

According to Option 2 and Choice c, for example, as illustrated in FIG. 13C, a UE may report delta RSSI value #i_1 for the TCI state index #i_1, delta RSSI value #i_2 for the TCI state index #i_2, . . . , delta RSSI value #i_n for the TCI state index #i_n in the ascending order of the TCI state indices together with a reference RSSI value. Here, the delta RSSI values #i_1 to #i_n are relative values representing offsets or differences to the reference RSSI value.

As Option 2, a UE may obtain measurement results for layer 3 (L3) for respective configured beams and report a single average value or composite value of the L3 measurement results. In other words, the UE obtains RSSI sample values for layer 1 (L1) for the respective configured beams and filter (for example, average or the like) the obtained RSSI sample values in layer 3 for the respective configured beams. Then, the UE may calculate an average value or a composite value for the RSSI values for the respective filtered beams and report the average value or composite value to a base station or others. According to Choice 2, only the single RSSI value is reported, which may lead to reduction in the amount of signaling.

In Choice 2-1, a UE may select several beams and report the average value of L3 RSSI values per beam for the respective selected beams. In other words, the UE obtains RSSI sample values in layer 1 (L1) for the respective measured beams and filters (for example, averages or the like) the obtained RSSI sample values in layer 3. Then, the UE may select some of the filtered L3 RSSI values and report the average of the selected L3 RSSI values to a base station or others. Here, the number of the selected L3 RSSI values may be defined by specifications or configured by an RRC. Alternatively, the L3 RSSI values greater than or equal to a threshold may be selected, and the threshold may be defined by specifications ore configured by an RRC. Also, the UE may report the TCI state indices (or indices in a configured beam list) together with the average of L3 RSSI values.

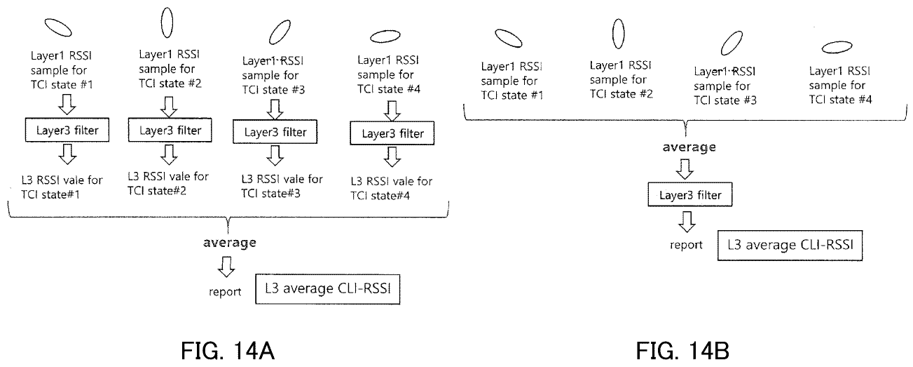

According to Option 2-1, for example, as illustrated in FIG. 14A, a UE measures respective beams for the configured TCI states #1 to #4 and obtain RSSI sample values in layer 1 for the respective beams. The UE filters the obtained RSSI values for the respective beams in layer 3 and reports the average value of the L3 RSSI values for the selected beams. In the illustrated example, all the TCI states #1 to #4 are selected for averaging, and the UE reports the average value of the L3 RSSI values of the TCI states #1 to #4.

In Option 2-2, a UE may select several beams, calculate an average value or a composite value of L1 RSSI sample values for the respective selected beams and report a filtering result in layer 3. In other words, the UE obtains the RSSI sample values in layer 1 (L1) for the respective measured beams and selects some of the obtained L1 RSSI sample values. Then, the UE calculates an average value or a composite value of the selected RSSI sample values and filters the average value or the composite value calculated in layer 3. Then, the UE may report the filtering result to a base station or others. Here, the number of the selected L1 RSSI sample values may be defined by specifications or configured by an RRC. Alternatively, the L1 RSSI sample values greater than or equal to a threshold may be selected, and the threshold may be defined by specifications or configured by an RRC. Also, the UE may report the TCI state indices (or indices in a configured beam list) of the selected beams together with the filtering result.

According to Option 2-2, for example, as illustrated in FIG. 14B, a UE measures respective beams for the configured TCI states #1 to #4 and obtains RSSI sample values for the respective beams in layer 1. The UE selects some of the obtained L1 RSSI sample values and calculates an average value of the selected RSSI sample values. Then, the UE filters the calculated average value of the RSSI sample values in layer 3 and reports the filtering result. In the illustrated example, all the TCI states #1 to #4 are selected for averaging, and the UE reports the average value of the L1 RSSI sample values for the TCI states #1 to #4.

Here, all or a portion of configured beams are described in the third problem.

As the third problem, it must be defined how to determine satisfaction of report criteria. For the third problem, the satisfaction of report criteria may be determined as follows. Specifically, it is discussed how to determine whether the report criteria are satisfied in cases where measurement results of CLI-RSSI are reported in reply to a predetermined event, for example, the case where reportType is configured to cli-EventTriggered. The report criteria condition may depend on report contents described in the above-stated second problem.

For Choice 1 for the second problem, options below are considered. As Option a, if the maximum, minimum or average of RSSI values for respective beams filtered in layer 3 is higher than or equal to a threshold, the measurement result of CLI-RSSI may be reported. In other words, upon detecting the maximum, minimum or average of the obtained L3 RSSI values for the respective beams is higher than or equal to the threshold, a UE may report the above-stated report contents as the measurement result of CLI-RSSI. Here, the threshold may be defined by specifications or configured by an RRC. Also, it may be defined by specifications or configured by an RRC which of the maximum, minimum or average of the RSSI values is applied as comparison to the threshold.

As Option b, if at least X RRSI values among filtered L3 RSSI values for respective beams are higher than or equal to a threshold, the measurement result of CLI-RSSI may be reported. In other words, upon detecting the X RRSI values higher than or equal to the threshold among the obtained L3 RSSI values for the respective beams, a UE may report the above-stated report contents as the measurement result of CLI-RSSI. Here, the threshold may be defined by specifications or configured by an RRC. Also, the X value may be defined by specifications or configured by an RRC.

As Option c, if the maximum, minimum or average of L3 RSSI values for respective N filtered beams randomly selected from the RSSI values filtered in layer 3 for the respective beams is higher than or equal to a threshold, the measurement result of CLI-RSSI may be reported. In other words, a UE may select the N L3 RSSI values from the obtained L3 RSSI values for the respective beams randomly and upon detecting that the maximum, minimum or average of the N L3 RSSI values is higher than or equal to a threshold, report the above-stated report contents as the measurement result of CLI-RSSI. Here, the threshold may be defined by specifications or configured by an RRC. Also, the N value may be defined by specifications or configured by an RRC.

For Choice 2 for the second problem, if the average value of L3 RSSI values is higher than or equal to a threshold, the measurement result of CLI-RSSI may be reported. In other words, upon detecting that the average value of the obtained L3 RSSI values for the respective beams, a UE may report the above-stated report contents as the measurement result of CLI-RSSI. Here, the threshold may be defined by specifications or configured by an RRC.

As the fourth problem, it must be defined which beam is measured in layer 1 for CLI-RSSI measurement resources where multiple TCI states are configured. For the fourth problem, beam measurement in layer 1 may be performed in accordance with Choices 1 and 2 below for CLI-RSSI measurement resources where multiple beams are configured.

As Choice 1, a UE may measure receive power for respective configured beams in layer 1. In other words, the UE may perform CLI-RSSI measurement for the respective beams where CLI-RSSI measurement resources are configured and obtain RSSI sample values in layer 1. The layer 1 RSSI sample values are measured for the respective beams where CLI-RSSI measurement resources are configured.

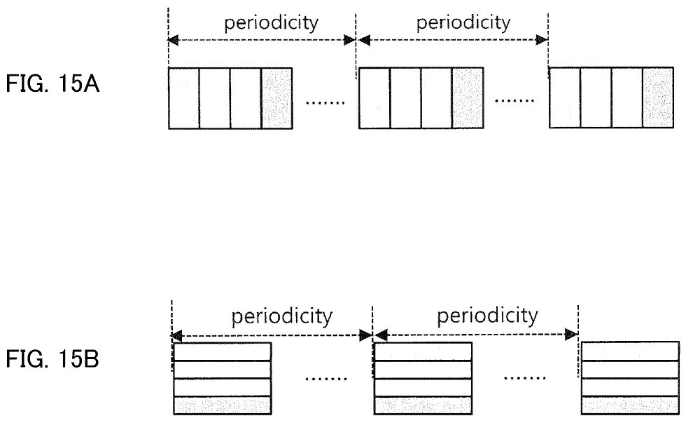

According to Choice 1, if four beams are configured for CLI-RSSI measurement, for example, as illustrated in FIG. 15A, a UE may measure receive power for the respective beams where CLI-RSSI measurement is configured in time resources in a periodicity and obtain layer 1 RSSI sample values based on receive power for the respective beams in the respective time resources.

Also, according to Choice 1, if four beams are configured for CLI-RSSI measurement, for example, as illustrated in FIG. 15B, a UE may measure receive power for respective beams where CLI-RSSI measurement is configured in frequency resources in a periodicity and obtain layer 1 RSSI sample values based on the receive power for the respective beams in respective frequency resources.

As Choice 2, a UE may measure receive power with received beams for a portion of configured beams in layer 1. In other words, the UE may perform CLI-RSSI measurement for a portion of beams where CLI-RSSI measurement resources are configured and obtain RSSI sample values in layer 1.

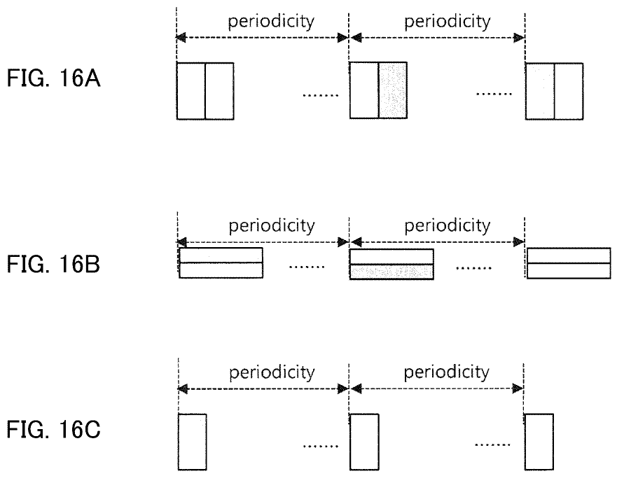

According to Choice 2, if four beams are configured for CLI-RSSI measurement, for example, as illustrated in FIG. 16A, a UE may measure receive power of a portion of beams where CLI-RSSI measurement is configured in time resources in a periodicity and obtain layer 1 RSSI sample values based on receive power of respective beams in the respective time resources. In the illustrated example, the receive power is measured for two of the four beams in adjacent time resources in a first periodicity and for others of the four beams in adjacent time resources in a second periodicity.

According to Choice 2, if the four beams are configured for CLI-RSSI measurement, for example, as illustrated in FIG. 16B, a UE may measure receive power of some of beams where CSI-RSSI measurement is configured in frequency resources in a periodicity and obtain layer 1 RSSI sample values based on the receive power of the respective beams in the respective frequency resources. In the illustrated example, the receive power is measured for two of the four beams in adjacent frequency resources in a first periodicity and others of the four beams in adjacent frequency resources in a second periodicity.

Also, according to Choice 2, if four beams are configured for CLI-RSSI measurement, for example, as illustrated in FIG. 16C, a UE may measure the receive power for a first beam of the four beams in certain time resources in a first periodicity, the receive power for a second beam of the four beams in certain time resources in a second periodicity, the receive power for a third beam of the four beams in certain time resources in a third periodicity, and the receive power for a fourth beam of the four beams in certain time resources in a fourth periodicity.

Here, the number of beams for measurement in a single periodicity may be defined by specifications or configured by an RRC or may be determined by the number of configured values for startPosition (and/or nrofSymbols) or the number of configured values for nrofPRBs (and/or startPRB).

Also, beams for measurement per frequency may be determined randomly (for example, M random TCI states in every TCI risk) or in a round Robin/sequential manner. According to the round Robin/sequential manner, for example, beams of TCI state indices #1 and #2 in the k-th cycle, beams of TCI state indices #3 and #4 in the (k+1)-th cycle, and beams of TCI states #1 and #2 in the (k+2)-the cycle and so on may be selected.

Also, the layer 1 RSSI sample values may be measured for the determined beams for measurement.

Meanwhile, if neither the explicit TCI state (or QCL-TypeD RS) nor the TCI state list (or QCL-TypeD RS list) is configured, a UE may envisage that one of the most recently received PDSCH and the most recently monitored CORESET is applied to CLI-RSSI measurement resources configured to QCL-TypeD.

As the fifth problem, it must be defined how to measure CLI-RSSI for multiple beams for CLI-RSSI measurement resources. For the fifth problem, for respective CLI-RSSI measurement resources with multiple to-be-measured beams in layer 1, a UE may measure receive power with multiple received beams (that is, TCI states) on the same resource elements (REs) simultaneously in time division multiplexing (TDM) scheme and/or frequency division multiplexing (FDM) scheme.

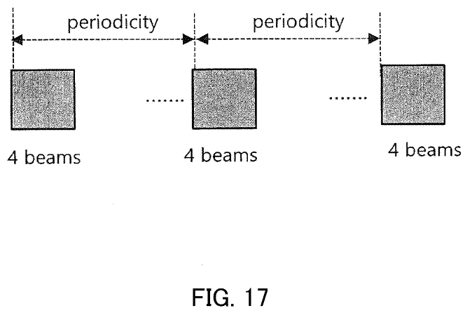

As Choice 0, a UE may measure receive power with multiple received beams on the same RE simultaneously. The UE may measure the receive power with configured received beams on respective measurement symbols configured by a CLI-RSSI resource configuration or on respective REs in a configured measurement resource block (RB) simultaneously. For example, as illustrated in FIG. 17, the UE may the four beams in each cycle simultaneously. Support of a UE for Choice 0 depends on UE capabilities.

As Choice 1, a UE may measure receive power with multiple received beams in TDM scheme. Specifically, the UE may measure the respective received beams in respective time-divided time resources, as illustrated in FIG. 15A.

As Choice 1-1, a set of values of only one of startPosition and nrofSymbols parameters may be configured.

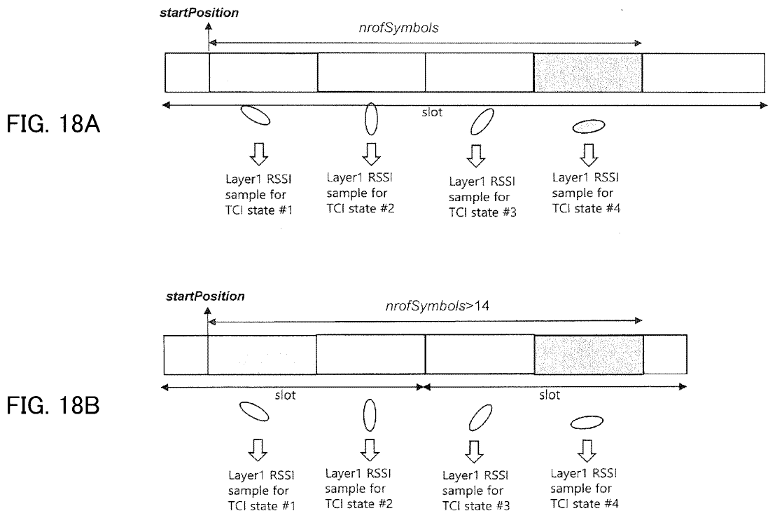

In Choice 1-1a, the parameter nrofSymbols may specify a total duration for measuring multiple received beams. For example, if four received beams are configured, a UE may measure the respective beams for the TCI states #1 to #4 in TDM scheme in the total measurement time of nrofSymbols from startPosition and obtain layer 1 RSSI sample values for the respective beams, as illustrated in FIG. 18A.

As exemplary variation 1, the value of nrofSymbols may be configured as an integer multiple of the number of received beams for measurement. As exemplary variation 2, if nrofSymbols is not configured as an integer multiple of the number of received beams for measurement, the measurement time for the first or last received beam for measurement may be configured to

$$\begin{matrix}( Expression 1 ) & \\ ⌈ \frac{n r o f S y m b o l s}{\# Rx beams for measuring} ⌉ . & [ 1 ]\end{matrix}$$

The measurement time of the remaining received beams may be configured to

$$\begin{matrix}( Expression 2 ) & \\ ⌈ \frac{n r o f S y m b o l s}{\# Rx beams for measuring} ⌉ . & [ 2 ]\end{matrix}$$

Also, a greater value than 14 may be supported for the nrofSymbols parameter. For example, if four received beams are configured, a UE may measure the respective beams for the TCI states #1 to #4 in TDM scheme in the total measurement time of nrofSymbols (where nrofSymbols >14) starting from startPosition and obtain layer 1 RSSI sample values for the respective beams, as illustrated in FIG. 18B. However, the parameter value of nrofSymbols should not be longer that the cycle of CLI-RSSI for CLI-RSSI measurement resources.

In Choice 1-1b, the parameter nrofSymbols may specify a duration for measuring respective received beams.

In Choice 1-1b-1, the multiple received beams may be measured in successive slots (slot basis). In the respective slots, the same startPosition and nrofSymbols may be applied. The first measurement slot may be determined by the same rssi-PeriodicityAndOffset as CLI-RSSI measurement slot in Rel-16.

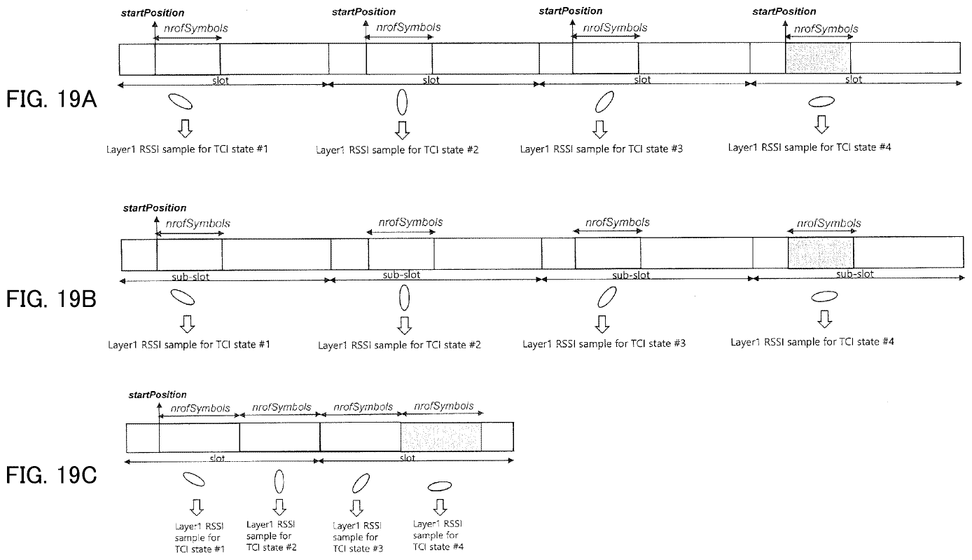

According to Choice 1-1b-2, if four received beams are configured, for example, a UE may measure the respective received beams in time resources defined by the same startPosition and nrofSymbols in each slot, as illustrated in FIG. 19A.

In Choice 1-1b-2, multiple received beams may be measured in successive subslots (subslot basis). In respective subslots, the same symbol offset and nrofSymbols may be applied to the start of the subslots. A first measurement subslot is determined by rssi-PeriodicityAndOffset and startPosition in the slot.

According to Choice 1-1b-2, if four received beams are configured, a UE may measure the respective received beams in time resources determined by the same startPosition and nrofSymbols in the respective subslots, as illustrated in FIG. 19B.

In Choice 1-1b-3, multiple received beams may be measured in successive symbols (back-to-back basis). In other words, the measurement of the next received beam starts after completion of the measurement of the current received beam.

According to Choice 1-1b-3, if four received beams are configured, for example, a UE may measure the respective received beams in every successive time resources from startPosition to nrofSymbols.

In Choice 1-2, a set of multiple values may be configured for the parameters startPosition and/or nrofSymbols, and the set of respective values corresponds to a single received beams.

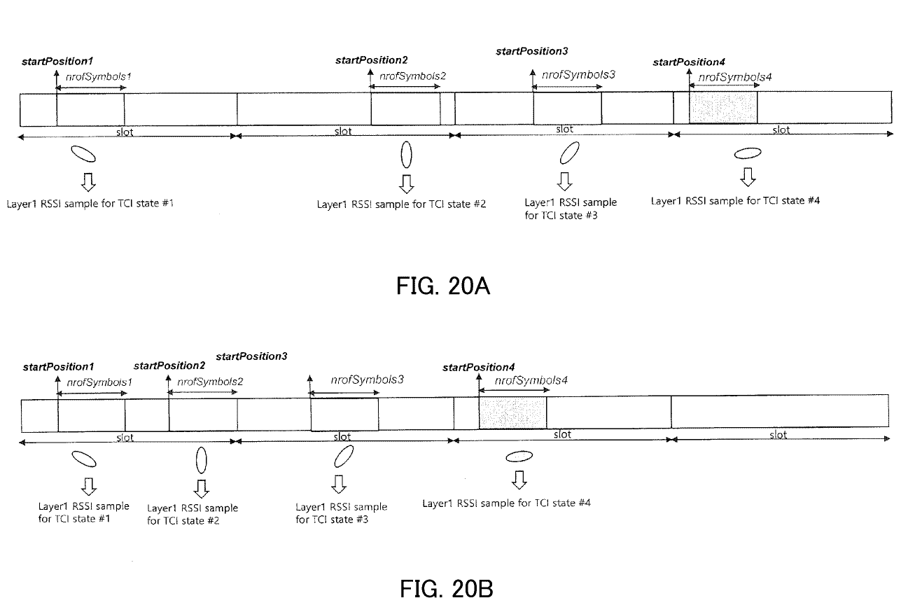

In Choice 1-2a, multiple received beams may be measured in successive slots, and startPosition indicates a symbol offset in the corresponding slot. According to Choice 1-2a, for example, if four received beams are configured and {startPosition1, nrofSymbols1} to {startPosition4, nrofSymbols4} are configured for the TCI states #1 to #4, respectively, a UE measures the respective received beams in the time resource arrangement as illustrated in FIG. 20A.

Here, if startPosition is not configured, multiple received beams may be measured in successive slots. startPosition may be applied to the respective received beams for measurement in the corresponding slot.

In Choice 1-2b, if startPosition indicates for a received beam the previous symbol for the measurement completion symbol of the previous received beam, that received beam may be measured in the next slot of the previous received beam, that is, in a symbol offset indicated by startPosition in the next slot. Otherwise, the received beam may be measured in the same slot as the previous received beam, that is, in the symbol offset indicated by startPosition in the same slot.

According to Choice 1-2b, for example, if four received beams are configured and {startPosition1, nrofSymbols1} to {startPosition4, nrofSymbols4} are configured, respectively, a UE measures the respective received beams in the time resource arrangement as illustrated in FIG. 20B. For example, startPosition3 of the TCI state #3 is positioned before the measurement completion symbol of the TCI state #2, and the UE measures the TCI state #3 from startPosition3 in the next slot. Similarly, startPosition4 of the TCI state #4 is positioned before the measurement completion symbol of the TCI state #3, and the UE measures the TCI state #4 from startPosition4 in the next slot.

Here, if only one startPosition is configured, multiple received beams may be measured in successive symbols. In other words, the measurement of the next received beam may start at a symbol after the measurement completion of the previous received beam.

In Option 1-3, only a single value may be configured for startPosition, and multiple values may be configured for nrofSymbols. Here, each value corresponds to a single received beam.

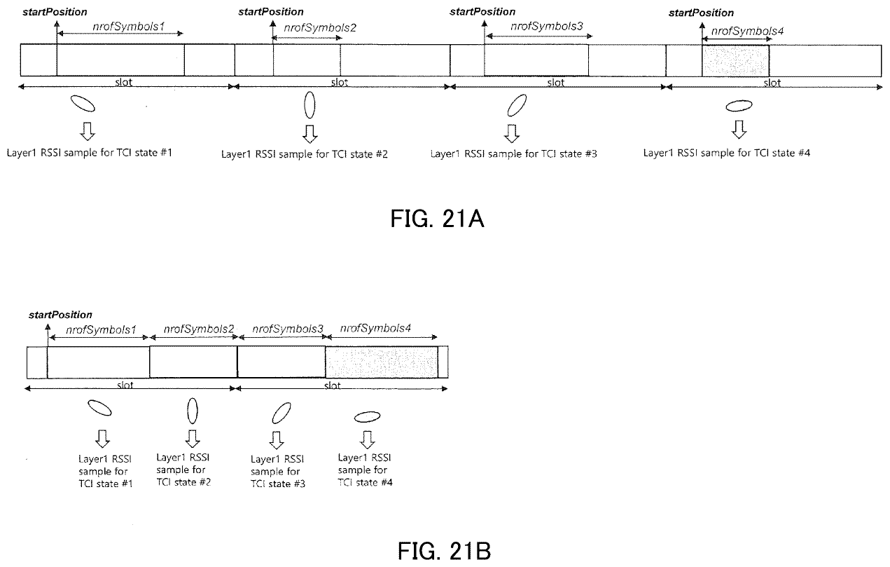

In Choice 1-3a, multiple received beams may be measured in successive slots. In other words, only a single value of startPosition may be applied to the received beams for measurement in the corresponding slot. According to Choice 1-3a, for example, if four received beams are configured and {startPosition, nrofSymbols1} to {startPosition, nrofSymbols4} are configured, respectively, a UE measures the respective received beams in the time resource arrangement as illustrated in FIG. 21A. In other words, the UE measures the respective received beams in the same symbol offset indicated in startPosition in each slot.

In Choice 1-3b, multiple received beams may be measured in successive symbols. In other words, the measurement of the next received beam may start at a symbol after completion of measurement of the previous received beam. For example, if four received beams are configured and nrofSymbols1 to nrofSymbols4 are configured for the TCI states #1 to #4, respectively, a UE measures the respective received beams in the time resource arrangement as illustrated in FIG. 21B. In other words, the UE measures the respective received beams in successive symbols from startPosition only for the corresponding duration.

In Choice 1-4, only a single value may be configured for nrofSymbols, multiple values may be configured for startPosition, and each value may correspond to a single received beam. The multiple received beams may be measured in successive slots, that is, only a single value of startPosition may be applied to the respective received beams for measurement in the corresponding slot.

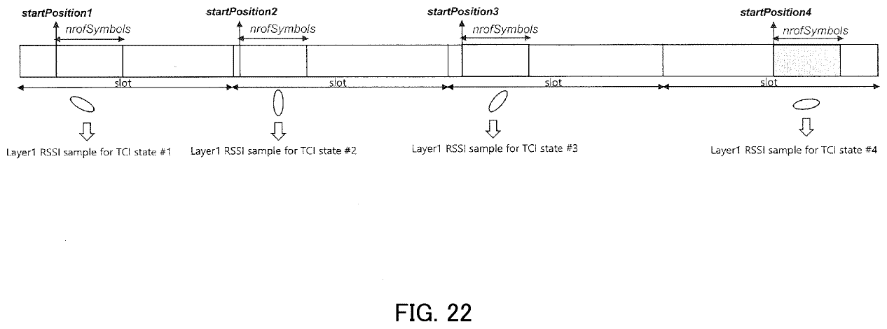

According to Choice 1-4, for example, if four received beams are configured and {startPosition1, nrofSymbols} to {startPosition4, nrofSymbols} are configured, respectively, a UE measures the respective received beams in the time resource arrangement as illustrated in FIG. 22. In other words, the UE measures the respective received beams in the same duration from different symbol offsets indicated in startPosition1 to 4 in each slot.

As an exemplary variation of Choice 1, it is not envisaged that multiple received beams are measured for CLI RSSI resources spanning CLI-RSSI cycles. Also, the measurement time for received beams spanning a slot/subslot boundary of a reference SCS is not envisaged. If the SCS of the configured DL BWP is larger than the reference SCS, a network may configure startPosition and nrofSymbols such that the configured CLI-RSSI resources do not exceed the slot boundary corresponding to the configured BWP SCS. Also, if the reference SCS is larger than the configured SCS of DL BWP, the start position and the number of symbols for measuring the respective received beams is an integer multiple of the reference SCS divided by the configured BWP SCS.

As stated above, a UE may measure receive power with multiple received beams (that is, TCI states) in TDM scheme and/or FDM scheme for the respective CLI-RSSI measurement resources with the multiple beams measured in layer 1 (as stated in the third problem). In Choice 2, the UE may measure the receive power for the respective received beams in FDM scheme, as illustrated in FIG. 15B.

As Choice 2-1, a set of only a single value of startPRB and nrofPRBs parameters may be configured.

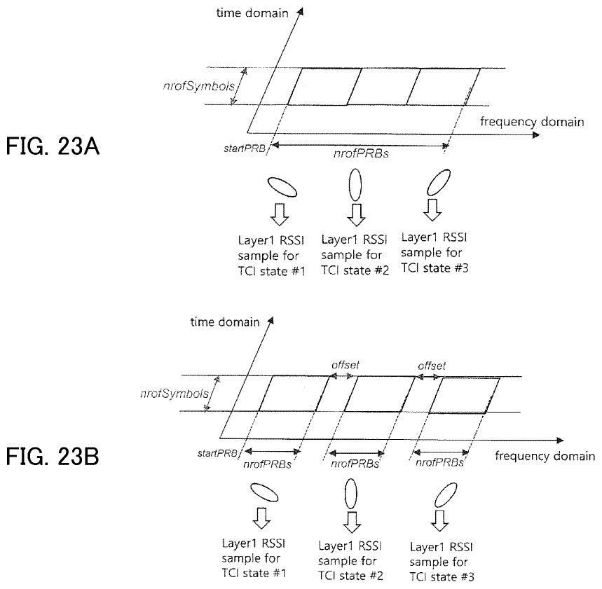

As Option 2-1a, the parameter nrofPRBs may specify the total number of PRBs for measuring multiple received beams, and the number of PRBs for measuring the respective received beams may be configured as the number of received beams for measurement or nrofPRBs. For example, if three received beams are configured, a UE may measure the respective beams of the TCI states #1 to #3 in FDM scheme in the total number of PRBs for nrofPRBs starting at startPRB and obtain layer 1 RSSI sample values for the respective beams, as illustrated in FIG. 23A.

As exemplary variation 1, the value of nrofPRBs may be configured as an integer multiple of the number of received beams for measurement or the number of received beams for measurement×4. As exemplary variation 2, if nrofPRBs is not configured as an integer multiple of the number of the received beams for measurement, the number of PRBs for measurement may be configured for the first or last received beam for measurement as follows,

$$\begin{matrix}( Expression 3 ) & \\ ⌈ \frac{nrofPRBs}{\# Rx beams for measuring} ⌉ . & [ 3 ]\end{matrix}$$

For the remaining received beams, the number of PRBs for measurement may be configured as follows,

$$\begin{matrix}( Expression 4 ) & \\ ⌈ \frac{nrofPRBs}{\# Rx beams for measuring} ⌉ . & [ 4 ]\end{matrix}$$

In Choice 2-1b, the parameter nrofPRBs indicates the number of PRBs for measuring the respective received beams. The offset between the end PRB of the previous beam and the start PRB of the subsequent beam may be defined by specifications or configured by an RRC. According to Choice 2-1b, for example, a UE may measure the respective received beams positioned separately by the offset in the frequency direction in FDM scheme, as illustrated in FIG. 23B.

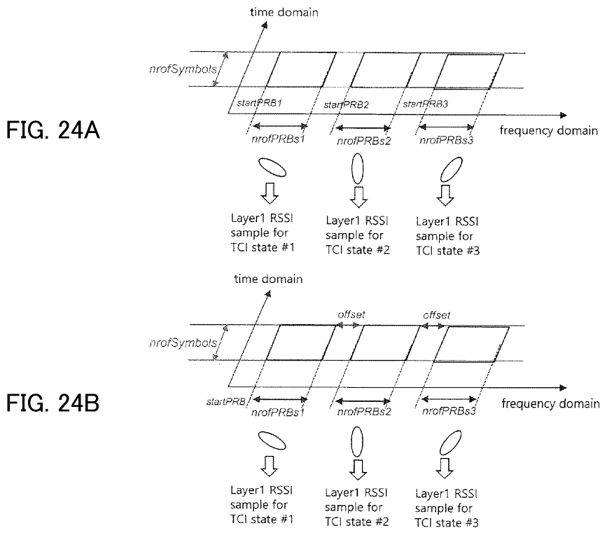

In Choice 2-2, a set of multiple values of the parameters startPRB and nrofPRBs may be configured. According to Choice 2-2, for example, if {startPRB1, nrofPRBs1} to {startPRB3, nrofPRBs3} are configured for the TCI states #1 to #3, respectively, a UE measures the respective received beams in the corresponding frequency resources, as illustrated in FIG. 24A.

In Choice 2-3, only one value is configured for startPRB, and multiple values may be configured for nrofPRBs. Each value corresponds to a single received beam. The offset between the end PRB of the received beam #i and the start PRB of the received beam #i+1 may be made constant, and the offset may be defined by specifications (for example, to zero) or configured by an RRC. If the offset is zero, the PRBs for measurement for multiple received beams may be successive. According to Choice 2-3, for example, a UE measures the received beams in the frequency band of the corresponding number of PRBs and separating in the frequency direction by the offset.

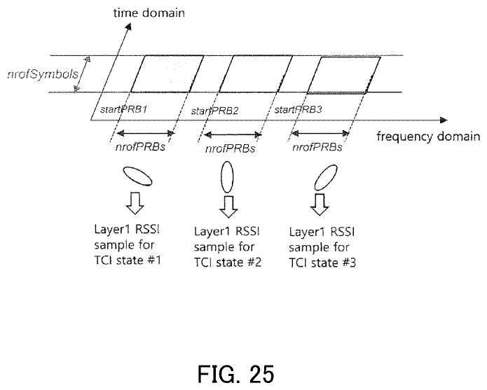

In Choice 2-4, only one value may be configured for nrofPRBs, and multiple values may be configured for startPRB. Each value corresponds to one received beam. According to Choice 2-4, for example, a UE measures the receive beams in the frequency band of the constant number of PRBs from different frequency positions, as illustrated in FIG. 25.

### Fourth Embodiment

One exemplary solution for obtaining multiple CLI-RSSI measurement results for different subbands is provided. In the fourth embodiment, subbands for CLI-RSSI measurement are considered. The subbands for CLI-RSSI measurement may differ between XDD time units and non-XDD time units. For example, configured subbands may be unavailable to DL, or discontinuous subband measurement may be needed for the XDD operation.

In Option 1, subbands for a CLI-RSSI measurement resource configuration may not be enhanced.

In Option 1-1, a UE may not envisage that CLI-RSSI resources include or overlap with XDD time units or XDD symbols.

In Option 1-2, if CLI-RSSI resources include or overlap with XDD time units or XDD symbols, a UE may not measure CLI-RSSI in the CLI-RSSI resources.

In Option 1-3, if subbands of CLI-RSSI resources overlap with time and frequency domain resources that are indicated or configured as UL, for UL transmission or as being unavailable for DL, a UE may not measure the CLI-RSSI in the CLI-RSSI resources.

In Option 2, interpretation of subbands for measurement may differ for CLI-RSSI resources in XDD time units and non-XDD time units. For the CLI-RSSI resources that do not include or overlap with the XDD time units or do not overlap with the XDD symbols, the parameters nrofPRBs and/or startPRB may be interpreted based on a frequency resource configuration of non-XDD time units. In other words, the parameters nrofPRBs and/or startPRB may be interpreted similar to Rel-15/16/17. On the other hand, for the CLI-RSSI resources including or overlapping with the XDD time units or overlapping with the XDD symbols, the parameters nrofPRBs and/or startPRB may be interpreted based on a frequency domain resource configuration of the overlapping XDD time units or XDD symbols.

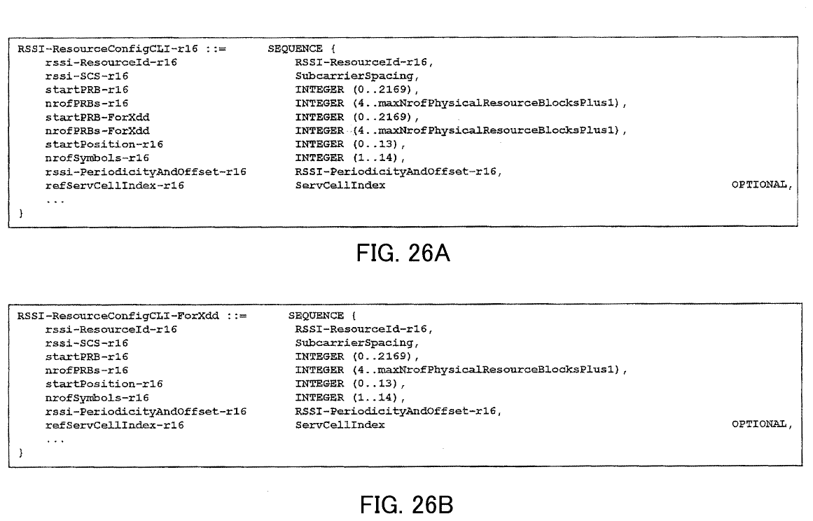

In Option 3, different subband configurations may be configured for the XDD time units and the non-XDD time units in the CLI-RSSI measurement resource configuration. For example, separate configurations may be indicated or configured for the parameter startPRB and/or nrofPRBs. If the CLI-RSSI resources do not include or overlap with the XDD time units or the XDD symbols, the existing parameters startPRB and nrofPRBs may be used to determine the subbands for measuring the CLI-RSSI resources. On the other hand, if the CLI-RSSI resources include or overlap with the XDD time units or the XDD symbols, new parameters startPRB-ForXdd and nrofPRBs-ForXdd may be used to determine subbands for measuring the CLI-RSSI resources. For example, the CLI-RSSI measurement resource configuration may include the existing parameters startPRB and nrofPRBs and the new parameters startPRB-ForXdd and nrofPRBs-ForXdd, as illustrated in FIG. 26A.

In Option 4, separate CLI-RSSI measurement resource configurations may be configured for the XDD time units and the non-XDD time units. For example, the CLI-RSSI resources configured by RSSI-ResourceConfigCLI-r16 or RSSI-ResourceConfigCLI-NonXdd may be applied to only the non-XDD time units. On the other hand, as illustrated in FIG. 26B, the new CLI-RSSI resource configuration RSSI-ResourceConfigCLI-Xdd may be applied to only the XDD time units. For the respective CLI-RSSI measurement resource configurations, a UE may determine the time domain position for CLI-RSSI measurement resources per cycle in accordance with existing rules in Rel-16, that is, based on rssi-PeriodicityAndOffset for determining slots of CLI-RSSI measurement resources or based on startPosition and nrofSymbols for determining symbols in slots.

For CLI-RSSI measurement resources configured for the non-XDD time units, that is, for the CLI-RSSI resources configured by RSSI-ResourceConfigCLI-r16 or RSSI-ResourceConfigCLI-NonXdd, a UE may operate as follows.

In Option 1, a UE may not envisage that the CLI-RSSI measurement resources configured for the non-XDD time units include or overlap with the XDD time units or the XDD symbols.

In Option 2, if the CLI-RSSI resources include or overlap with the XDD time units, a UE may not measure the CLI-RSSI in the CLI-RSSI resources.

On the other hand, for CLI-RSSI measurement resources configured for the XDD time units, that is, for the CLI-RSSI resources configured by RSSI-ResourceConfigCLI-ForXdd, a ULE may operate as follows.

In Option 1, a UE may not envisage that the CLI-RSSI measurement resources configured for the XDD time units include or overlap with the non-XDD time units.

In Option 2, if the CLI-RSSI resources include or overlap with the non-XDD time units, a UE may not measure the CLI-RSSI in the CLI-RSSI resources.

### Fifth Embodiment

One exemplary solution for obtaining multiple CLI-RSSI measurement results for different subbands is provided. According to the fifth embodiment, the CLI-RSSI measurement for the multiple subbands may be supported.

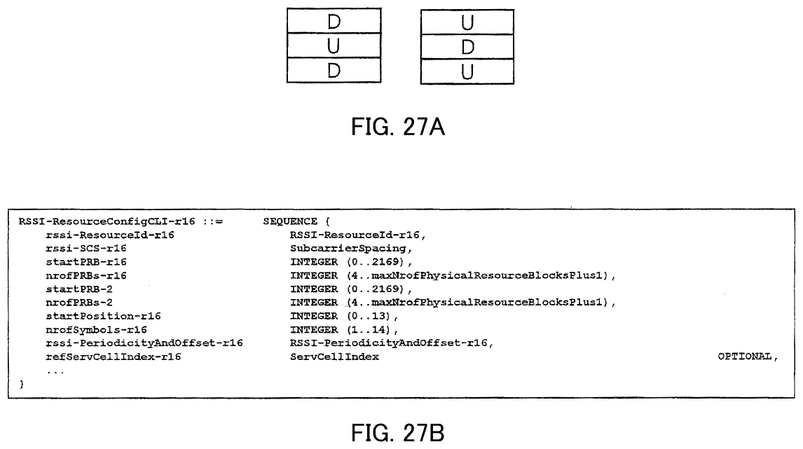

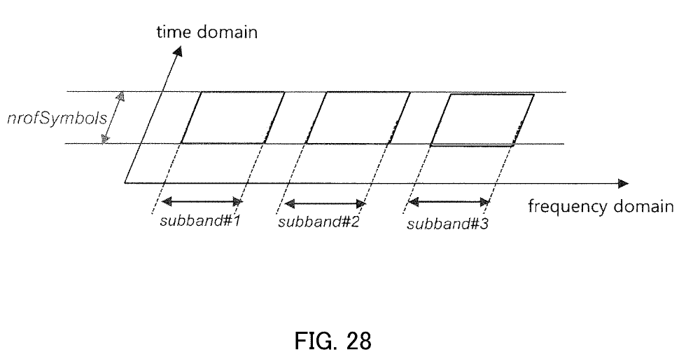

In the fifth embodiment, multiple discontinuous (or continuous) subbands may be configured for CLI-RSSI measurement in a CLI-RSSI measurement resource configuration. A main motivation is to support discontinuous subband CLI-RSSI measurement. For example, as illustrated in FIG. 27A, a discontinuous DL/UL subband is enabled for the XDD operation.

In Example 1, a set of multiple values may be configured for the parameters startPRB and nrofPRBs, as illustrated in FIG. 27B.

In Example 2, a set of multiple values may be configured for startPRB. For nrofPRBs, only one value can be applied to respective subband, that is, the respective subbands have the same subband size. As one exemplary variation, overlapping of multiple subbands configured for one CLI-RSSI resource may not be envisaged.

AUE may measure and report the CLI-RSSI for configured subbands.

In Choice 1, a UE may obtain L3 measurement results for respective configured subbands and select a to-be-reported subband. In other words, the UE may obtain L1 RSSI sample values per subband and obtain and report L3 RSSI values per subband for the respective filtered subbands.

In Choice 1-1, a UE may report RSSI values per subband for respective subbands. In other words, the UE may obtain RSSI sample values in layer 1 (L1) for the respective measured subbands, filter (for example, average) the obtained RSSI sample values in layer 3 for the respective subbands and report the filtered RSSI values as the RSSI value per subband to a base station or others.

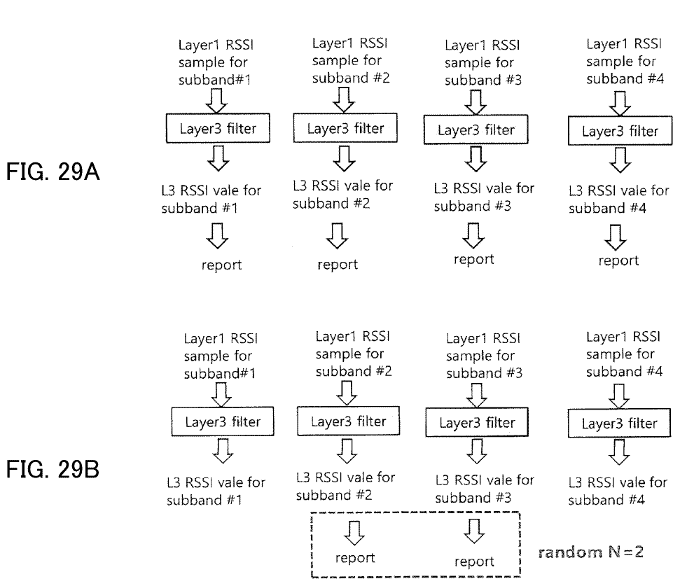

According to Choice 1-1, for example, as illustrated in FIG. 29A, a UE measures the configured subbands #1 to #4 and obtain the RSSI sample values for the respective subbands in layer 1. The UE filters the obtained RSSI sample values for the respective subbands in layer 3 and reports the RSSI values for the respective subbands. In this manner, the UE reports the RSSI values for all the subbands #1 to #4.

In Choice 1-2, a UE may report the RSSI values per subband for randomly selected N RSSI values. In other words, the UE may obtain RSSI sample values in layer 1 (L1) for respective measured subbands, filter (for example, average) the obtained RSSI sample values for the respective subbands in layer 3, and report randomly selected N RSSI values from the filtered RSSI values as the RSSI values per subband to abase station or others. Here, the N value may be defined by specifications or configured by an RRC.

According to Choice 1-2, for example, as illustrated in FIG. 29B, a UE measures configured subbands #1 to #4 and obtains RSSI sample values for the respective subbands in layer 1. The UE filters the obtained RSSI sample values for the respective subbands in layer 3 and reports randomly selected N RSSI values. In the illustrated example, the two RSSI values for subbands #2 and #3 are selected, and the UE reports the RSSI values for subbands #2 and #3.

In Choice 1-3, a UE a UE may report the RSSI values per subband for the RSSI values higher than or equal to a threshold. In other words, the UE obtains the RSSI sample values in layer 1 (L1) for the respective measured subbands and filters (for example, averages) the obtained RSSI sample values in layer 3 for the respective subbands. Then, the UE may report the RSSI values higher than or equal to the threshold among the filtered RSSI values as the RSSI values per subband to a base station or others. Here, the threshold may be defined by specifications or configured by an RRC.

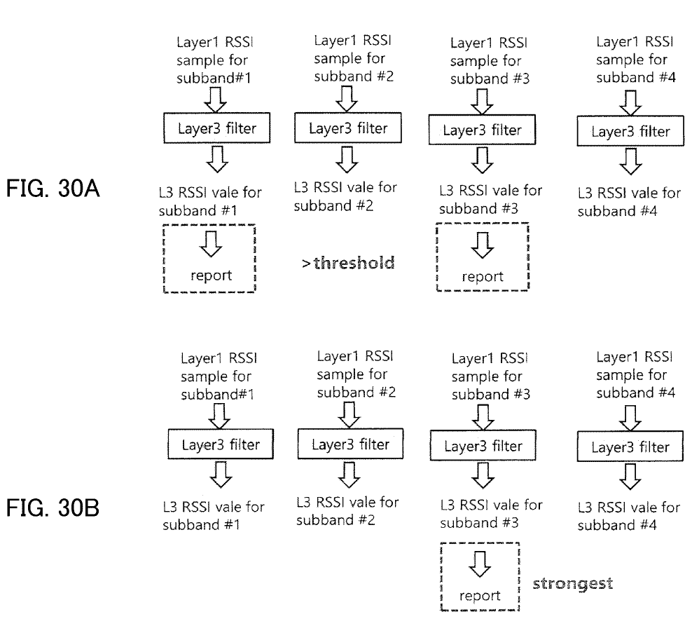

According to Choice 1-3, for example, as illustrated in FIG. 30A, a UE measures configured subbands #1 to #4 and obtains RSSI sample values for the respective subbands in layer 1. The UE filters the obtained RSSIU sample values for the respective subbands in layer 3 and reports the RSSI values higher than or equal to a threshold. In the illustrated example, the two SSI values for subbands #1 and #3 is higher than or equal to the threshold, and the UE reports the RSSI values for subbands #1 and #3.

In Choice 1-4, a UE may report the RSSI values per subband for the N highest or lowest RSSI values. In other words, the UE obtains RSSI sample values in layer 1 (L1) for the respective measured subbands and filters (for example, averages) the obtained RSSI sample values for the respective subbands in layer 3. Then, the UE may report the N highest or lowest RSSI values among the filtered RSSI values as the RSSI values per subband to a base station or others. Here the N value may be defined by specifications or configured by an RRC.

According to Choice 1-4, for example, as illustrated in FIG. 30B, a UE measures configured subbands #1 to #4 and obtains RSSI sample values for the respective subbands in layer 1. The UE filters the obtained RSSI sample values for the respective subbands in layer 3 and reports the highest RSSI value. In the illustrated example, N=1 and the RSSI value for subband #3 is the maximum. The UE reports the RSSI value for subband #3.

As Choice 2, a UE may obtain layer 3 (L3) measurement results for respective configured beams and report one average or composite value of the L3 measurement results. In other words, the UE obtains layer 1 (L1) RSSI sample values for the respective configured subbands and filters (for example, averages) the obtained RSSI sample values in layer 3 for the respective subbands. Then, the UE may calculate the average value or the composite value for the filtered RSSI values per subband and report the average value or the composite value to a abase station or others. According to Choice 2, only the single RSSI value is reported, which leads to reduction in signaling amounts.

In Choice 2-1, a UE may select several subbands and report the average value of L3 RSSI values per subband for the selected subbands. In other words, the UE obtains RSSI sample values in layer 1 (L1) for respective measured subbands and filters (for example, averages) the obtained RSSI sample values in layer 3 for the respective subbands. Then, the UE may select several L3 RSSI values among the filtered L3 RSSI values and report the average value for the selected L3 RSSI values to a base station or others. Here, the number of selected L3 RSSI values may be defined by specifications or configured by an RRC. Alternatively, the L3 RSSI values higher than or equal to a threshold may be selected, and the threshold may be defined by specifications or configured by an RRC. Also, the UE may report the average value of the L3 RSSI values as well as subband indices of the selected subbands.

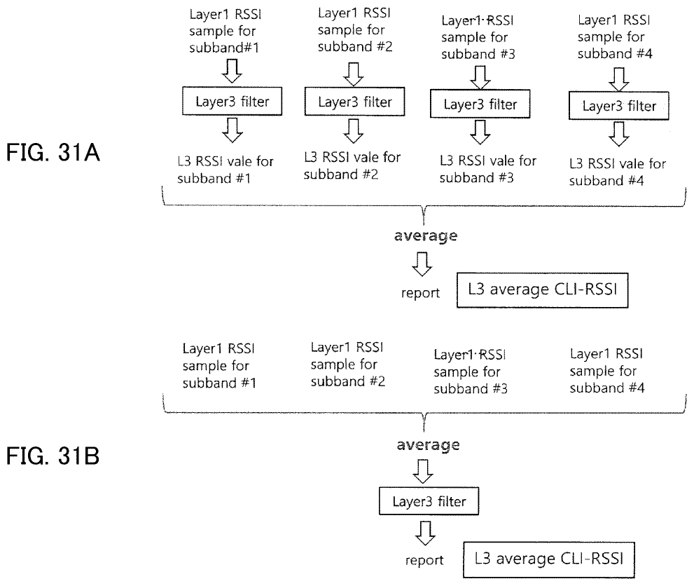

According to Choice 2-1, for example, illustrated in FIG. 31A, a UE measures configured subbands #1 to #4 and obtains RSSI sample values for the respective subbands in layer 1. The UE filters the obtained RSSI sample values for the respective subbands in layer 3 and reports the average value of L3 RSSI values for the selected subbands. In the illustrated example, all the subbands #1 to #4 are selected for averaging, and the UE reports the average value of the L3 RSSI values for the subbands #1 to #4.

In Choice 2-2, a UE may select several subbands, calculate an average value or a composite value of L1 RSSI sample values per subband for the selected subbands, and report the filtered results in layer 3. In other words, the UE obtains RSSI sample values in layer 1 (L1) for the respective measured subbands and selects several L1 RSSI sample values among the obtained L1 RSSI sample values. Then, the UE calculates an average value or a composite value of the selected RSSI sample values and filters the calculated average value and the composite value in layer 3. Then, the UE may report the filtered results to a base station or others. Here, the number of selected L1 RSSI sample values may be defined by specifications or configured by an RRC. Alternatively, the L1 RSSI sample values higher than or equal to a threshold may be selected, and the threshold may be defined by specifications or configured by an RRC. Also, the UE may report the filtered results as well as the selected subband indices.

According to Choice 2-2, for example, as illustrated in FIG. 31B, a UE measures configured subbands #1 to #4 and obtains RSSI sample values for the respective subbands in layer 1. The UE selects several L1 RSSI sample values among the obtained L1 RSSI sample values and calculates an average value of the selected RSSI sample values. Then, the UE filters the calculated average value of RSSI sample values in layer 3 and reports filtered results. In the illustrated example, all the subbands #1 to #4 are selected for averaging, and the UE reports the average value of L1 RSSI sample values for the subbands #1 to #4.

In Choice 2-3, a single L1 RSSI sample value is obtained for multiple subbands, and the filtered results in layer 3 may be reported.

The above-stated third embodiment relates to CLI-RSSI measurement and report per beam, and the fifth embodiment relates to CLI-RSSI measurement and report per subband. The third and fifth embodiments may be applied to CLI-RSSI measurement in combination.

As stated above, according to Choice 1, multiple RSSI values per subband may be reported. In this case, several options may be considered for ordering of RSSI values in measurement reports.

As Option 1, a to-be-reported RSSI value may be ordered in the ascending order or the descending order of subband indices. For example, RSSI values for subband indices #1, #2, . . . , #n are reported, a UE may report RSSI value #1 for subband index #1, RSSI value #2 for subband index #2, . . . , RSSI value #n for subband index #n in the ascending order of subband indices. Alternatively, if the RSSI values for subband indices #1, #2, . . . , #n are reported, a UE may report RSSI value #n for subband index #n, RSSI value #n−1 for subband index #n−1, . . . , RSSI value #1 for subband index #1 in the descending order of subband indices. Here, selection of the ascending order or the descending order may be defined by specifications or configured by an RRC.

As Option 2, to-be-reported RSSI values may be ordered in the ascending order or the descending order of RSSI values. For example, if the RSSI values for subband indices #1, #2, . . . , #n are reported, a UE may report the lowest RSSI value #i_1 and the corresponding subband index #i_1, the second lowest RSSI value #i_2 and the corresponding subband index #i_2, . . . , the highest RSSI value #i_n and the corresponding subband index #i_n in the ascending order of RSSI values. Alternatively, the UE may report the highest RSSI value #j_1 and the corresponding subband index #j_1, the second highest RSSI value #j_2 and the corresponding subband index #j_2, . . . , the lowest RSSI value #j_n and the corresponding subband index #j_n in the descending order of RSSI values. Here, selection of the ascending order or the descending order may be defined by specifications or configured by an RRC.

Also, it may be defined by specifications or configured by an RRC which option is applied.

Also, for the format of a to-be-reported RSSI value, several choices may be considered.

As Option a, {subband index, RSSI value} is reported, and the respective RSSI values may be reported in their absolute values.

As Option b, {subband index, RSSI value} is reported, and a first RSSI value may be reported in its absolute value whereas the RSSI values other than the first RSSI value may be reported in relative values. For example, the relative value may be a delta RSSI value representing an offset or a difference to the first RSSI value.

A reference RSSI value (for example, maximum/minimum/average RSSI value or the like) as the absolute value of RSSI may be reported, and {subband index, RSSI value} may be reported. The RSSI value herein may be a relative value (for example, a delta RSSI value representing an offset or a difference to the reported RSSI absolute value). Also, if a predetermined RSSI value is applied as the reference RSSI value, the reference RSSI value may not be reported. The predetermined RSSI value may be defined by specifications or configured by an RRC.

Note that the absolute value may be an m-bit value in the range [a, b] dBm by the step size c dB. Here, the RSSI bit length m, the lower bound a, the upper bound b and the step size c may be defined by specifications or configured by an RRC. For example, similar to the current specifications, the absolute value may be a 7-bit value in the range [−100, −50] dBm by the step size 1 dB. Here, the RSSI bit length n, the lower bound a1, the upper bound b1 and the step size c1 may be defined by specifications or configured by an RRC.

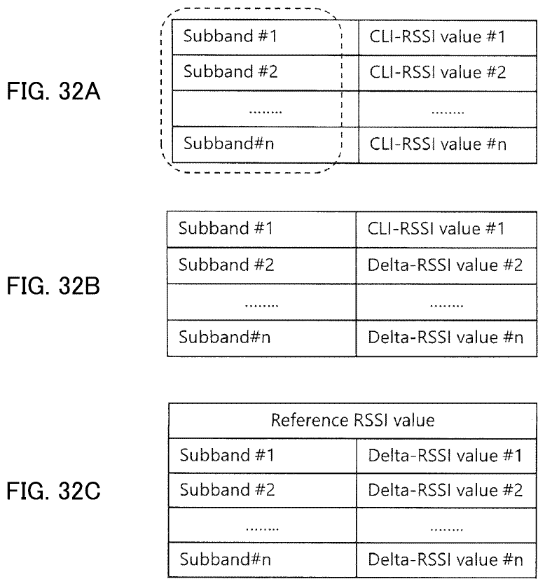

According to Option 1 and Choice a, for example, as illustrated in FIG. 32A, a UE may report RSSI value #1 for subband index #1, RSSI value #2 for subband index #2, . . . , RSSI value #n for subband index #n in the ascending order of subband indices. Here, the RSSI values #1 to #n are absolute values of RSSI. Note that if a UE always reports the RSSI values for the respective configured subbands in the ascending order or the descending order of subband indices, the subband indices may not be explicitly reported.

According to Option 1 and Choice b, for example, as illustrate in FIG. 32B, a UE may report RSSI value #1 for subband index #1, delta RSSI value #2 for subband index #2, . . . , delta RSSI value #n for subband index #n in the ascending order of subband indices. Here, the RSSI value #1 is the absolute value of RSSI, and the RSSI values #2 to #n are relative values indicative of offsets or differences to the RSSI value #1.

According to Option 1 and Choice c, for example, as illustrate in FIG. 32C, a UE may report a reference RSSI value as well as delta RSSI value #1 for subband index #1, delta RSSI value #2 for subband index #2, . . . , delta RSSI value #n for subband index #n in the ascending order of subband indices. Here, the delta RSSI values #1 to #n are relative values indicative of offsets or differences to the reference RSSI value.

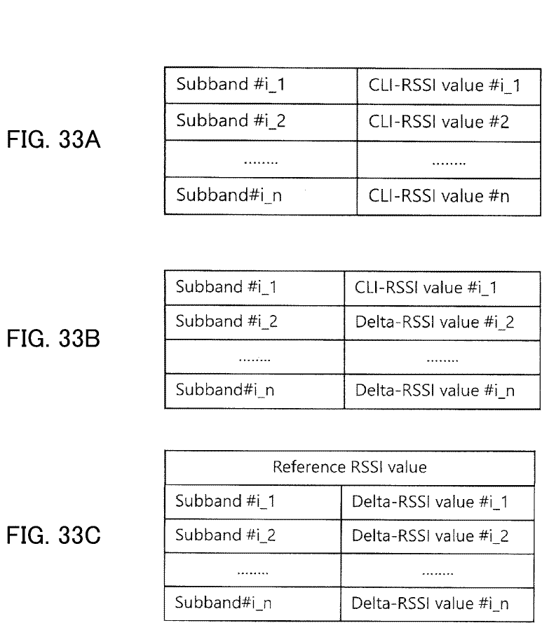

According to Option 2 and Choice a, for example, as illustrated in FIG. 33A, a UE may report RSSI value #i_1 for subband index #i_1, RSSI value #i_2 for subband index #i_2, . . . , RSSI value #i_n for subband index #i_n in the ascending order of RSSI values. Here, the RSSI values #i_1 to #i_n are absolute values of RSSI.

According to Option 2 and Choice b, for example, as illustrate in FIG. 33B, a UE may report RSSI value #i_1 for subband index #i_1, delta RSSI value #i_2 for subband index #i_2, . . . , delta RSSI value #i_n for subband index #i_n in the ascending order of RSSI values. Here, the RSSI value #i_1 is the absolute value of RSSI, and the RSSI values #i_2 to #i_n are relative values indicative of offsets or differences to the RSSI value #i_1.

According to Option 2 and Choice c, for example, as illustrate in FIG. 33C, a UE may report a reference RSSI value as well as delta RSSI value #i_1 for subband index #i_1, delta RSSI value #i_2 for subband index #i_2, . . . , delta RSSI value #i_n for subband index #i_n in the ascending order of RSSI values. Here, the delta RSSI values #i_1 to #i_n are relative values indicative of offsets or differences to the reference RSSI value.

As an exemplary variation, a UE may not be able to measure multiple discontinuous (or continuous) subbands simultaneously. In a first exemplary variation, a UE may measure CLI-RSSI for multiple discontinuous (or continuous) subbands in TDM scheme. For example, Choice 1 regarding the fifth problem for the third embodiment may be reused.

In a second exemplary variation, a UE may measure CLI-RSSI on one or a portion of multiple subbands in one RSSI cycle. The UE may determine the subbands for measurement randomly or in a round Robin/sequential manner. According to the round Robin/sequential manner, for example, subband index #1 may be selected in the k-th cycle, subband index #2 may be selected in the (k+1)-th cycle, subband index #3 may be selected in the (k+2)-th cycle, and so on.

For the above-stated embodiments, applied embodiments, options and/or operations may be indicated or configured by upper layer parameters, may be indicated or configured by a UE as UE capability information, may be defined by specifications, or may be determined by configurations of upper layer parameters and the reported UE capability information.

In order to implement the XDD operation, a UE may transmit UE capability information regarding CLI-RSSI measurement and report to a base station, and the base station may indicate or configure the CLI-RSSI measurement for the UE based on the received UE capability information. Specifically, the UE capability information regarding whether to support the CLI-RSSI measurement and report for FR2-2, the CLI-RSSI measurement and report for a larger SCS (for example, SCS for 480 kHz and/or 960 kHz) and/or the CLI-RSSI measurement and report for unlicensed spectrum may be defined.

The UE capability information regarding whether support more than 64 CLI-RSSI measurement resources, more than 8 CLI reports, beam specific CLI-RSSI measurement and report, single beam CLI-RSSI measurement, and/or multi-beam CLI-RSSI measurement for CLI-RSSI resources may be defined.

The UE capability information regarding whether to support separate CLI-RSSI resource configurations for XDD time units and non-XDD time units, separate subband configurations in a CLI-RSSI resource configuration for XDD time units and non-XDD time units, a multi-subband configuration in a CLI-RSSI resource configuration, and/or a discontinuous subband configuration in a CLI-RSSI resource configuration may be defined.

### (Hardware Configuration)

Note that, the block diagrams used to describe the above embodiment illustrate blocks on the basis of functions. These functional blocks (components) are implemented by any combination of at least hardware or software items. Implementation manners of the functional blocks are not particularly limited. That is, the functional blocks may be implemented using one physically or logically coupled apparatus. Also, two or more physically or logically separate apparatuses may be directly or indirectly connected (for example, via wires or in the air), and the plurality of apparatuses may be used to implement the functional blocks. The functional blocks may be implemented by combining software items with the one apparatus or the plurality of apparatuses described above.

The functions may include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component) that functions to achieve transmission is referred to as “a transmitting unit” or “a transmitter”. The implementation manners of the functions are not particularly limited as described above.

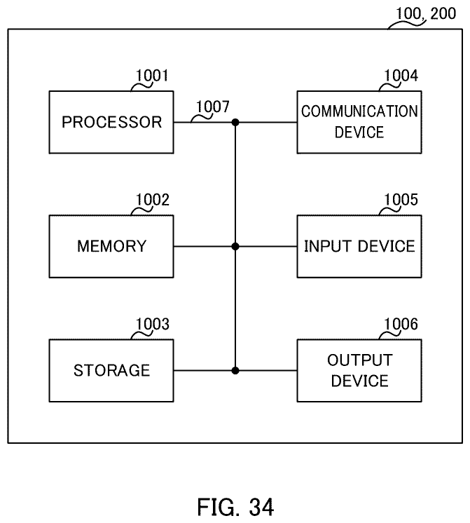

For example, a base station, a user terminal and the like according to one embodiment of the present disclosure may function as a computer that executes processing of radio communication methods of the present disclosure. FIG. 34 illustrates an exemplary hardware arrangement of the base station and the user terminal according to one embodiment of the present disclosure. The base station 10 and the user terminal 20 as stated above may be physically arranged as a computer device including a processor 1001, a memory 1002, a storage 1003, a communication device 1004, an input device 1005, an output device 1006, a bus 1007, and the like.

Note that the term “apparatus” in the following description can be replaced with a circuitry, a device, a unit, or the like. The hardware arrangements of the base station 10 and the user terminal 20 may include one or more of the devices illustrated in FIG. 34 or may not include a part of the devices.

The functions of the base station 10 and the user terminal 20 may be implemented by predetermined software items (programs) loaded into a hardware item, such as the processor 1001, the memory 1002, and the like, to cause the processor 1001 to perform an operation or control communication by the communication device 1004 or at least one of reading and writing of data from/in the memory 1002 and the storage 1003.

The processor 1001 executes an operating system to control the entire computer, for example. The processor 1001 may be composed of a central processing unit (CPU) including an interface with peripheral devices, a controller, an arithmetic device, a register, and the like. For example, the baseband signal processing unit 104, the call processing unit 105 and the like as described above may be implemented using the processor 1001.

Also, the processor 1001 loads a program (program code), a software module, data, and the like from at least one of the storage 1003 and the communication device 1004 to the memory 1002 and performs various types of processing in accordance with the program (program code), the software module, the data, and the like. As the program, a program for causing the computer to perform at least a part of the operations described in the above embodiments may be used. For example, the control unit 401 of the user terminal 20 may be implemented using a control program stored in the memory 1002 and executed by the processor 1001, and the other functional blocks may also be implemented similarly. While it has been described that the various types of processing as described above may be performed by the single processor 1001, the various types of processing may be performed by the two or more processors 1001 in parallel or sequentially. The processor 1001 may be implemented using one or more chips. Note that the program may be transmitted from a network through a telecommunication line.

The memory 1002 is a computer-readable storage medium and may be composed of, for example, at least one of a Read Only Memory (ROM), an Erasable Programmable ROM (EPROM), an Electrically Erasable Programmable ROM (EEPROM), and a Random Access Memory (RAM). The memory 1002 may be called as a register, a cache, a main memory (main storage device), or the like. The memory 1002 can save a program (program code), a software module, and the like that can be executed to perform a radio communication method according to one embodiment of the present disclosure.

The storage 1003 is a computer-readable storage medium and may be composed of, for example, at least one of an optical disk such as a Compact Disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may also be called as an auxiliary storage device. The storage medium as described above may be, for example, a database, a server, or other appropriate media including at least one of the memory 1002 and the storage 1003.

The communication device 1004 is hardware (transceiver device) for communication between computers through at least one of wired and wireless networks and is also called as, for example, a network device, a network controller, a network card, or a communication module. The communication device 1004 may be configured to include a high frequency switch, a duplexer, a filter, a frequency synthesizer, and the like in order to achieve at least one of Frequency Division Duplex (FDD) and Time Division Duplex (TDD), for example. For example, a transmission and reception antenna 101, an amplification unit 102, a transmission and reception unit 103, a channel interface 106 and the like as stated above may be implemented using the communication device 1004. The transmission and reception unit 103 may be implemented as being physically or logically separated into a transmission unit 103a and a reception unit 103b.

The input device 1005 is an input device (for example, a keyboard, a mouse, a microphone, a switch, a button, or a sensor) that receives inputs from the outside. The output device 1006 is an output device (for example, a display, a speaker, or an LED lamp) which feeds outputs to the outside. Note that the input device 1005 and the output device 1006 may be integrated (for example, a touch panel).

Also, the respective devices, such as the processor 1001, the memory 1002, and the like are connected by the bus 1007 for communication of information. The bus 1007 may be arranged using a single bus or using buses different between each pair of the devices.

Also, the base station 10 and the user terminal 20 may be arranged to include hardware items such as a microprocessor, a digital signal processor (DSP), an application specific integrated circuit (ASIC), a programmable logic device (PLD), a field programmable gate array (FPGA) and the like, and a portion or all of the respective functional blocks may be implemented by the hardware items. For example, the processor 1001 may be implemented using at least one of these hardware items.

Indication of information is not limited to the aspects or embodiments described in the present disclosure, and the information may be indicated in other manners. For example, information may be indicated or signaled by a physical layer signaling (for example, Downlink Control Information (DCI) and Uplink Control Information (UCI)), upper layer signaling (for example, Radio Resource Control (RRC) signaling, Medium Access Control (MAC) signaling, broadcast information (Master Information Block (MIB), and System Information Block (SIB))) or other signals or combinations thereof. Also, the RRC signaling may be referred to as an RRC message and may be, for example, an RRC connection setup message, an RRC connection reconfiguration message, or the like.

The aspects and embodiments described in the present disclosure may be applied to at least one of systems using Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark) or other appropriate systems and a next-generation system enhanced based on the above systems. Also, combinations of multiple systems (e.g., a combination of at least LTE or LTE-A and 5G) may be applied.

The orders of the processing procedures, the sequences, the flow charts, and the like of the aspects and embodiments described in the present disclosure may be changed as long as there is no contradiction. For example, for the methods described in the present disclosure, elements of various steps are presented in exemplary orders, but the methods are not limited to the presented specific orders.

In some cases, specific operations which are described in the present disclosure as being performed by a base station may be performed by an upper node. Various operations performed for communication with a terminal in a network constituted by one or more network nodes including the base station can be obviously performed by at least one of the base station and a network node other than the base station (for examples, an MME or a S-GW, but not limited to, may be conceived). Although the case where there is one network node in addition to the base station has been illustrated above, a plurality of other network nodes may be combined (for example, an MME and an S-GW).

Information and the like (the item “information and signaling” may be referred to) can be fed from a higher layer (or a lower layer) to a lower layer (or a higher layer). The information and the like may be fed in or out through a plurality of network nodes.

Input and output information and the like may be saved in a specific place (for example, a memory) or may be managed using a management table. The input and output information and the like can be overwritten, updated, or additionally written. The output information and the like may be deleted. The input information and the like may be transmitted to another apparatus.

Determination may be made based on a value represented by one bit (0 or 1), based on a Boolean value (true or false), or based on comparison with a numerical value (for example, comparison with a predetermined value).

The aspects and embodiments described in the present disclosure may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiments described in the present disclosure. Modifications and variations of the aspects of the present disclosure can be made without departing from the spirit and the scope of the present disclosure defined by the description of the appended claims. Therefore, the description of the present disclosure is intended for exemplary description and does not limit the present disclosure in any sense.

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information, and the like may be transmitted and received through a transmission medium. For example, if the software is transmitted from a website, a server, or another remote source by using at least one of a wired technique (e.g., a coaxial cable, an optical fiber cable, a twisted pair, and a digital subscriber line (DSL)) and a wireless technique (e.g., an infrared ray and a microwave), the at least one of the wired technique and the wireless technique is included in the definition of the transmission medium.

The information, the signals, and the like described in the present disclosure may be represented by using any of various different techniques. For example, data, instructions, commands, information, signals, bits, symbols, chips, and the like that may be mentioned throughout the above description may be represented by voltage, current, electromagnetic waves, magnetic fields, magnetic particles, optical fields or photons or arbitrary combinations thereof.

Note that terminologies described in the present disclosure and terminologies necessary to understand the present disclosure may be replaced with those having the same or similar meaning. For example, at least one of channels and symbols may be a signal (signaling). The signal may be a message. Also, a component carrier (CC) may be called a carrier frequency, a cell, a frequency carrier, or the like.

The terms “system” and “network” used in the present disclosure can be interchangeably used.

Information, parameters, and the like described in the present disclosure may be represented using an absolute value, using a value relative to a predetermined value, or using other corresponding information. For example, radio resources may be indicated by indices.

The names used for the above-stated parameters are not limitative in any respect. Furthermore, the numerical formulas and the like using the parameters may be different from the ones explicitly disclosed in the present disclosure. Various channels (for example, a PUCCH and a PDCCH) and information elements can be identified by any suitable names, and various names assigned to these various channels and information elements are not limitative in any respect.

In the present disclosure, the terms “Base Station (BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, and “component carrier” may be used interchangeably. The base station may be referred to as a macro cell, a small cell, a femtocell, a pico cell or the like.

The base station can accommodate one or more (for example, three) cells. If the base station accommodates a plurality of cells, the entire coverage area of the base station can be divided into a plurality of smaller areas, and each of the smaller areas can provide a communication service based on a base station subsystem (for example, a remote radio head (RRH) serving as an indoor small base station). The term “cell” or “sector” denotes a part or all of the coverage area of at least one of the base station and the base station subsystem that perform a communication service in the coverage.

In the present disclosure, transmission of information from a base station to a terminal may be replaced with instructions of control and operation from the base station to the terminal based on the information.

In the present disclosure, the terms “Mobile Station (MS)”, “user terminal”, “User Equipment (UE)”, “terminal” and the like may be used interchangeably.

The mobile station may be referred to by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terminologies.

At least one of a base station and a mobile station may be referred to as a transmitter, a receiver, a communication apparatus, or the like. Note that at least one of the base station and the mobile station may be a device mounted in a mobility, the mobility itself, or the like. The mobility may be, but not limited to, a vehicle, a transport vehicle, an automobile, a motorcycles, a bicycle, a connected car, an excavator, a bulldozer, a wheel loader, a dump truck, a forklift, a train, a bus, a rear carriage, a rickshaw, a ship (ship and other watercraft), an aircraft, a rocket, a satellite, a drone (registered trademark), a multicopter, a quadcopter, a balloon, and articles mounted thereon. The mobility may also be a mobile entity that runs autonomously based on operational commands. It may be a vehicle (e.g., car, airplane, etc.), an unmanned moving vehicle (e.g., drone, self-driving car, etc.), or a robot (manned or unmanned). Note that at least one of the base station and the mobile station may also include an apparatus that does not necessarily move during communication operation. For example, at least one of the base station and the mobile station may be an Internet-of-Things (IoT) equipment such as a sensor.

Also, the base station in the present disclosure may be interchanged with the user terminal. For example, the aspects and the embodiments of the present disclosure may be applied to an arrangement where communications between the base station and the user terminal is replaced with communications between multiple user terminals (for example, such communication may be referred to as device-to-device (D2D), vehicle-to-everything (V2X), or the like). In this case, the terminal 20 may be configured to have the same functionalities as those of the above-stated base station 10. Also, the wordings “uplink” and “downlink” may be replaced with corresponding wordings for inter-terminal communication (for example, “side”). For example, an uplink channel, a downlink channel, and the like may be replaced with a side channel.

Similarly, a terminal in the present disclosure may be replaced with a base station. In this case, the base station 10 is configured to have the same functionalities as those of the above-stated user terminal 20.

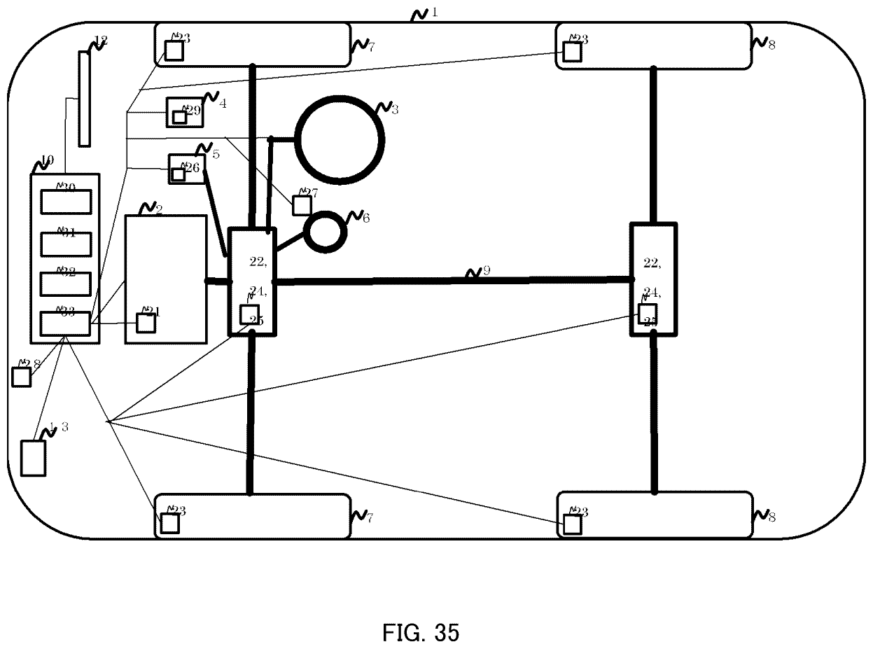

FIG. 35 illustrates an exemplary arrangement of a vehicle 1. As illustrated in FIG. 35, the vehicle 1 includes a driving unit 2, a steering unit 3, an accelerator pedal 4, a brake pedal 5, a shift lever 6, front wheels 7, rear wheels 8, an axle 9, an electronic controller 10, various sensors 21 to 29, an information service unit 12 and a communication module 13.

The driving unit 2 may be composed of an engine, a motor or a hybrid of the engine and the motor, for example.

The steering unit 3 may at least include a steering wheel (which is also called a handle) and be arranged to steer at least one of the front wheels and the rear wheels based on user's operation of the steering wheel.

The electronic controller 10 is composed of a microprocessor 31, a memory (ROM, RAM) 32 and a communication port (IO port) 33. Signals from the various sensors 21 to 27 incorporated in the vehicle are fed to the electronic controller 10. The electronic controller 10 may be referred to as an ECU (Electronic Control Unit).

The signals fed from the various sensors 21 to 28 may include a current signal from a current sensor 21 for sensing the current of a motor, an engine speed signal for the front or rear wheels obtained with an engine speed sensor 22, an air pressure signal for front or rear wheels obtained with an air pressure sensor 23, a vehicle speed signal obtained with a vehicle speed sensor 24, an acceleration signal obtained with an acceleration sensor 25, a stepping-in amount signal of an accelerator pedal obtained with an accelerator pedal sensor 29, a stepping-in amount signal of a brake pedal obtained with a brake pedal sensor 26, an operating signal of a shift lever obtained with a shift lever sensor 27, and a detection signal for detecting an obstacle, a vehicle, a pedestrian and the like obtained with an object detection sensor 28.

The information service unit 12 may be composed of various equipments for providing various information items such as driving information, traffic information, entertainment information, for example, a car navigation system, an audio system, a speaker, a television set and a radio set, and one or more ECUs for controlling these equipments. The information service unit 12 may use information obtained from an external device via the communication module 13 and the like to provide various multimedia information items and multimedia services to an occupant in the vehicle 1.

The information service unit 12 may include input devices for receiving inputs from external devices (for example, a keyboard, a mouse, a microphone, a switch, a button, a sensor, a touch panel and the like) and output devices for outputting to external devices (for example, a display, a speaker, a LED lump, a touch panel and the like).

A driving assistance system unit 30 may be composed of various equipments for providing functionalities for preventing an accident before it happens or reducing driving load of a driver, for example, a millimeter-wave radar, a LiDAR (Light Detection and Ranging), a camera, a positioning locator (for example, a GNSS or the like), map information (for example, a high definition (HD) map, an autonomous vehicle (AV) map and the like), a gyro system (for example, an IMU (inertial Measurement Unit), an INS (Inertial Navigation System) and the like), an AI (Artificial Intelligence) chip, and an AI processor, and one or more ECUs for controlling these equipments. Also, the driving assistance system unit 30 may transmit and receive various information items via the communication module 13 to implement a driving assistance functionality and an autonomous driving functionality.

The communication module 13 may communicate with the microprocessor 31 and components in the vehicle 1 via a communication port. For example, the communication module 13 transmits and receives data to and from the driving unit 2, the steering unit 3, the accelerator pedal 4, the brake pedal 5, the shift lever 6, the front wheels 7, the rear wheels 8 and the axle 9 provided in the vehicle 1, the microprocessor 31 and the memory (ROM, RAM) 32 in the electronic controller 10 and the sensors 21 to 28.

The communication module 13 is a communication device that can be controlled by the microprocessor 31 in the electronic controller 10 and communicate with an external device. For example, the communication module 13 may transmit and receive various information items to and from the external device in the air. The communication module 13 may be inside or outside the electronic controller 10. The external device may be a base station, a mobile station and the like, for example.

The communication module 13 may transmit at least one of signals from the above-stated various sensors 21-28 incoming into the electronic controller 10, information obtained based on the signals and information incoming from an external one (user) via the information service unit 12 to external devices via radio communication. The electronic controller 10, the various sensors 21-28, the information service unit 12 and the like may be referred to as an input unit for accepting inputs. For example, a PUSCH transmitted by the communication module 13 may include the information based on the above-stated inputs.

The communication module 13 receives various types of information (traffic information, traffic light information, vehicle distance information and others) and displays the information items to the information service unit 12 installed into the vehicle 1. The information service unit 12 may be referred to as an output unit for outputting information (feeding information to devices such as a display, a speaker and the like based on a PDSCH (or data/information decoded from the PDSCH) received at the communication module 13).

The communication module 13 stores various types of information received from an external device in the memory 32 available to the microprocessor 31. The driving unit 2, the steering unit 3, the accelerator pedal 4, the brake pedal 5, the shift lever 6, the front wheels 7, the rear wheels 8, the axle 9, the sensors 21-28 and others mounted in the vehicle 1 may be controlled by the microprocessor 31 based on the information items stored in the memory 32.

### Summary of Embodiments

As stated above, according to one aspect of the present disclosure, there is provided a terminal including a receiver that receives a beam-based cross link interference measurement configuration, and a transmitter that transmits measurement results per beam obtained in accordance with the cross link interference measurement configuration.

According to this arrangement, beam specific cross link interference can be measured and reported.

In one embodiment, the cross link interference measurement configuration may configure to-be-measured beams. According to this embodiment, beams for cross link interference measurement can be configured.

In one embodiment, the transmitter may transmit a measurement result extracted from measurement results per beam for the configured to-be-measured beams. According to this embodiment, all or a part of the measurement results per beam for the configured beams can be reported.

In one embodiment, the beam configured in the cross link interference measurement configuration may be measured in radio resources arranged in TDM (Time Division Multiplexing) scheme or FDM (Frequency Division Multiplexing) scheme. According to this embodiment, the beam can be measured in various time and frequency resources.

Also, according to one aspect of the present disclosure, there is provided a base station including a transmitter that transmits a cross link interference measurement configuration per beam; and a receiver that receives measurement results per beam obtained in accordance with the cross link interference measurement configuration.

According to the above arrangement, beam specific cross link interference can be measured and reported.

Also, according to one aspect of the present disclosure, there is provided a terminal implemented radio communication method including receiving a cross link interference measurement configuration per beam, and transmitting measurement results per beam obtained in accordance with the cross link interference measurement configuration.

According to the above arrangement, beam specific cross link interference can be measured and reported.

Also, according to one aspect of the present disclosure, there is provided a terminal including a receiver that receives a subband based cross link interference measurement configuration; and a transmitter that transmits measurement results per subband obtained in accordance with the cross link interference measurement configuration.

According to the above arrangement, subband specific cross link interference can be measured and reported.

In one embodiment, the cross link interference measurement configuration may configure to-be-measured subbands. According to this embodiment, the subband for cross link interference measurement can be configured.

In one embodiment, the transmitter may transmit a measurement result extracted from the measurement results per subband for the configured to-be-measured subbands. According to this embodiment, all or a part of measurement results per subband for the configured subbands can be reported.

In one embodiment, the subbands configured in the cross link interference measurement configuration may be measured in radio resources arranged in TDM (Time Division Multiplexing) scheme or FDM (Frequency Division Multiplexing) scheme. According to this embodiment, the subband can be measured in various time and frequency resources.

Also, according to one aspect of the present disclosure, there is provided a base station including a transmitter that transmits a cross link interference measurement configuration per subband; and a receiver that receives measurement results per subband obtained in accordance with the cross link interference measurement configuration.

According to the above arrangement, subband specific cross link interference can be measured and reported.

Also, according to one aspect of the present disclosure, there is provided a terminal implemented radio communication method including receives a cross link interference measurement configuration per subband; and a transmitter that transmits measurement results per subband obtained in accordance with the cross link interference measurement configuration.

According to the above arrangement, subband specific cross link interference can be measured and reported.

### Supplement of Embodiments

As used herein, the term “determining” may encompass a wide variety of actions. For example, “determining” may be regarded as judging, calculating, computing, processing, deriving, investigating, looking up, searching (or, search or inquiry) (e.g., looking up in a table, a database or another data structure), ascertaining and the like. Furthermore, “determining” may be regarded as receiving (for example, receiving information), transmitting (for example, transmitting information), inputting, outputting, accessing (for example, accessing data in a memory) and the like. Also, “determining” may be regarded as resolving, selecting, choosing, establishing, comparing and the like. That is, “determining” may be regarded as a certain type of action related to determining. Also, “determining” may be replaced with “assuming”, “expecting”, “considering”, and the like.

The terms “connected” and “coupled” as well as any derivatives of the terms mean any direct or indirect connection and coupling between two or more elements, and the terms can include cases in which one or more intermediate elements exist between two “connected” or “coupled” elements. The coupling or the connection between elements may be a physical or logical coupling or connection or may be a combination of the physical and logical couplings or connections. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like that are non-limiting and non-inclusive examples.

A reference signal can also be abbreviated as an RS and may also be called as a pilot depending on the applied standard.

The recitation “based on” used in the present disclosure does not mean “based only on”, unless otherwise specified. In other words, the recitation “based on” means both of “based only on” and “based at least on”.

Any reference to elements by using the terms “first”, “second”, and the like that are used in the present disclosure does not generally limit the quantities of or the order of these elements. These terms can be used in the present disclosure as a convenient manner of distinguishing between two or more elements. Therefore, reference to first and second elements does not mean that only the two elements can be employed, or that the first element has to precede the second element somehow.

The “means” in the arrangements of the above respective apparatuses may be replaced with “unit”, “circuitry”, “device”, or the like.

In cases where terms “include”, “including”, and their derivatives are used in the present disclosure, these terms are intended to be inclusive like the term “comprising”. Further, the term “or” used in the present disclosure is not intended to be an exclusive OR.

A radio frame may be constituted by one or more frames in the time domain. The one frame or each of the plurality of frames may be referred to as a subframe in the time domain. The subframe may be further constituted by one or more slots in the time domain. The subframe may have a fixed time length (e.g., 1 ms) independent of numerology.

The numerology may be a communication parameter that is applied to at least one of transmission and reception of a certain signal or channel. For example, the numerology may indicate at least one of SubCarrier Spacing (SCS), a bandwidth, a symbol length, a cyclic prefix length, a Transmission Time Interval (TTI), the number of symbols per TTI, a radio frame arrangement, a specific filtering processing that is performed by a transceiver in the frequency domain, a specific windowing processing that is performed by the transceiver in the time domain, and the like.

The slot may be constituted by one or more symbols (e.g., an Orthogonal Frequency Division Multiplexing (OFDM) symbol, a Single Carrier-Frequency Division Multiple Access (SC-FDMA) symbol, or the like) in the time domain. The slot may also be a time unit based on the numerology.

The slot may include a plurality of mini-slots. Each of the mini-slots may be constituted by one or more symbols in the time domain. Furthermore, the mini-slot may be referred to as a subslot. The mini-slot may be constituted by a smaller number of symbols than the slot. APDSCH (or a PUSCH) that is transmitted in the time unit longer than the mini-slot may be referred to as a PDSCH (or a PUSCH) mapping type A. The PDSCH (or the PUSCH) that is transmitted using the mini-slot may be referred to as a PDSCH (or PUSCH) mapping type B.

The radio frame, the subframe, the slot, the mini slot, and the symbol indicate time units in transmitting signals. The radio frame, the subframe, the slot, the mini slot, and the symbol may be referred to as other corresponding names.

For example, one subframe, a plurality of continuous subframes, one slot, or one mini-slot may be referred to as a Transmission Time Interval (TTI). Namely, at least one of the subframe and the TTI may be a subframe (1 ms) in the existing LTE or have a duration (for example, 1 to 13 symbols) shorter than 1 ms or a duration longer than 1 ms. Note that a unit that represents the TTI may be referred to as a slot, a mini-slot, or the like instead of a subframe.

Here, the TTI, for example, refers to a minimum time unit for scheduling in radio communication. For example, in an LTE system, an IAB node performs scheduling for allocating a radio resource (a frequency bandwidth, a transmit power, and the like that are available to each user terminal) on the unit of TTI to each user terminal. Note that the definition of TTI is not limited to this.

The TTI may be a time unit for transmitting a channel-coded data packet (a transport block), a code block, or a codeword, or may be a unit for processing such as scheduling and link adaptation. Note that, when the TTI is assigned, a time section (for example, the number of symbols) to which the transport block, the code block, the codeword, or the like is actually mapped may be shorter than the TTI.

Note that, in the case where one slot or one mini-slot is referred to as the TTI, one or more TTIs (that is, one or more slots, or one or more mini-slots) may be a minimum time unit for the scheduling. Furthermore, the number of slots (the number of mini-slots) that compose the minimum time unit for the scheduling may be controlled.

A TTI having a time length of 1 ms may be referred to as a regular TTI (a TTI in LTE Rel. 8 to LTE Rel. 12), a normal TTI, a long TTI, a regular subframe, a normal subframe, a long subframe, a slot, or the like. A TTI shorter than the regular TTI may be referred to as a shortened TTI, a short TTI, a partial TTI (or a fractional TTI), a shortened subframe, a short subframe, a mini-slot, a subslot, a slot, or the like.

Note that the long TTI (for example, the regular TTI, the subframe, or the like) may be replaced with the TTI that has a time length which exceeds 1 ms, and the short TTI (for example, the shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be identical regardless of the numerology, and may be 12, for example. The number of subcarriers that are included in the RB may be determined based on the numerology.

In addition, the RB may include one or more symbols in the time domain, and may have a length of one slot, one mini slot, one subframe, or one TTI. One TTI and one subframe may be constituted by one or more resource blocks.

Note that one or more RBs may be referred to as a Physical Resource Block (PRB), a Sub-Carrier Group (SCG), a Resource Element Group (REG), a PRB pair, an RB pair, or the like.

In addition, the resource block may be constituted by one or more Resource Elements (REs). For example, one RE may be a radio resource region of one subcarrier and one symbol.

A bandwidth part (BWP) (which may be referred to as a partial bandwidth or the like) may represent a subset of contiguous common resource blocks (RB) for certain numerology in a certain carrier. Here, the common RBs may be identified by RB indices that use a common reference point of the carrier as a reference. The PRB may be defined by a certain BWP and may be numbered within the BWP.

The BWP may include a UL BWP and a DL BWP. A terminal may be configured with one or more BWPs within one carrier.

At least one of the configured BWPs may be active, and the terminal does not have to assume transmission/reception of a predetermined signal or channel outside the active BWP. Note that “cell”, “carrier”, and the like in the present disclosure may be replaced with “BWP”.

Structures of the radio frame, the subframe, the slot, the mini-slot, the symbol, and the like as described above are merely illustrative. For example, the arrangement such as the number of subframes that are included in the radio frame, the number of slots per subframe or radio frame, the number of mini-slots that are included within the slot, the numbers of symbols and RBs that are included in the slot or the mini-slot, the number of subcarriers that are included in the RB, the number of symbols within the TTI, the symbol length, the Cyclic Prefix (CP) length, and the like can be changed in various ways.

The term “maximum transmit power” as described in the present disclosure may mean the maximum value of transmit power, the nominal UE maximum transmit power or the rated UE maximum transmit power.

In cases where articles, such as “a”, “an”, and “the” in English, for example, are added in the present disclosure by translation, nouns following these articles may have the same meaning as used in the plural.

The expression “A differs from B” may mean “A mutually differs from B” in the present disclosure. Note that the expression may mean “A and B each differs from C.” The terminologies “separate”, “couple” or the like may be interpreted similar to “differ”.

### REFERENCE SYMBOLS LIST

10 Radio communication system
100 Base station (gNB)
200 Terminal (UE)

1. A terminal, comprising:
a receiver that receives a beam-based cross link interference measurement configuration; and
a transmitter that transmits measurement results per beam obtained in accordance with the cross link interference measurement configuration.

2. The terminal as claimed in claim 1, wherein the cross link interference measurement configuration configures to-be-measured beams.

3. The terminal as claimed in claim 2, wherein the transmitter transmits a measurement result extracted from measurement results per beam for the configured to-be-measured beams.

4. The terminal as claimed in claim 1, wherein the beam configured in the cross link interference measurement configuration is measured in radio resources arranged in TDM (Time Division Multiplexing) scheme or FDM (Frequency Division Multiplexing) scheme.

5. Abase station, comprising:
a transmitter that transmits a cross link interference measurement configuration per beam; and
a receiver that receives measurement results per beam obtained in accordance with the cross link interference measurement configuration.

6. A terminal implemented radio communication method, comprising:
receiving a cross link interference measurement configuration per beam; and
transmitting measurement results per beam obtained in accordance with the cross link interference measurement configuration.
